(19) United States
(12) Patent Application Publication
(10) Pub. No.: US 2020/0174844 A1
(43) Pub. Date: Jun. 4, 2020

(54) SYSTEM AND METHOD FOR RESOURCE PARTITIONING IN DISTRIBUTED COMPUTING

(71) Applicants: HUAWEI TECHNOLOGIES CANADA CO., LTD., Kanata (CA); THE GOVERNORS OF THE UNIVERSITY OF CALGARY, Calgary (CA)

(72) Inventors: Shane Bergsma, Markham (CA); Amir Kalbasi, Calgary (CA); Diwakar Krishnamurthy, Calgary (CA)

(21) Appl. No.: 16/209,287

(22) Filed: Dec. 4, 2018

(51) Int. Cl. G06F 9/50; G06F 9/48

(52) U.S. Cl. CPC G06F 9/5077; G06F 9/48; G06F 2209/505; G06F 2209/5011; G06F 9/5066

(57) ABSTRACT

A method for resource allocation in a distributed computing system receives data indicative of a total number of computing resources in a compute cluster of the distributed computing system, generates resource pools in accordance with the total number of computing resources, each of the plurality of resource pools associated with a quantity of computing resources that is included in one or more partitions of the total quantity of resources; assigns a weight to each of the resource pools based on the quantity of computing resources associated with each resource pool; and sends the resource pools and the weights assigned to each resource pool to a scheduler of the compute cluster.

### FIELD

This relates to distributed computing systems, and in particular, to systems and methods for managing the allocation of computing resources in distributed computing systems.

### BACKGROUND

In distributed computing, such as cloud computing systems, a collection of jobs forming a workflow are typically run by a collection of computing resources, each collection of computing resources referred to as a compute cluster.

In a typical enterprise data processing environment, there are two tiers of systems. A business workflow tier manages the workflow dependencies and their life cycles, and may be defined by a particular service level provided to a given customer in accordance with a formally negotiated service level agreement (SLA). SLAs can often mandate strict timing and deadline requirements for workflows. An underlying resource management system tier (or “control system”) schedules individual jobs based on various policies.

The business workflow tier addresses higher level dependencies, without knowledge of underlying resource availability and when and how to allocate resources to critical jobs. The underlying resource management system tier may only have knowledge of individual jobs, but no knowledge of higher-level job dependencies and deadlines.

The business SLA may be connected to the underlying resource management system by way of an SLA planner. Such an SLA planner may create resource allocation plans for jobs, and the resource allocation plans may be dynamically submitted to the underlying resource management system for resource reservation enforcement by a scheduler of the underlying resource management system.

However, some schedulers do not support a mechanism to enforce resource reservations, and thus cannot receive resource allocation plans. As such, it becomes difficult to guarantee that sufficient resources are available for critical workflows such that important workflows are able to complete before their deadline.

Accordingly, there is a need for an improved system and method for allocating resources to a workflow.

### SUMMARY

According to an aspect, there is provided a method in a distributed computing system comprising: receiving data indicative of a total number of computing resources in a compute cluster of the distributed computing system; generating a plurality of resource pools in accordance with the total number of computing resources, each of the plurality of resource pools associated with a quantity of computing resources that is included in one or more partitions of the total quantity of resources; assigning a weight to each of the plurality of resource pools based on the quantity of computing resources associated with each resource pool; and sending the plurality of resource pools and the weights assigned to each resource pool to a scheduler of the compute cluster.

In some embodiments, the method further comprises: receiving, from a job submitter of the distributed computing system, a job identifier for a job; selecting a resource pool of the plurality of resource pools for the job based on a resource allocation for the job, the resource allocation indicative of a number of computing resources in the compute cluster allocated for execution of the job; and sending the selected resource pool to the job submitter.

In some embodiments, the sending the selected resource pool to the job submitter comprises sending the selected resource pool to the job submitter for submission to the scheduler, and for the scheduler to assign computing resources in the compute cluster for execution of the job based on the selected resource pool.

In some embodiments, the selected resource pool is associated with the quantity of computing resources to which another job has not been assigned.

In some embodiments, the method further comprises: receiving, from the job submitter of the distributed computing system, a second job identifier for a second job; selecting a second resource pool of the plurality of resource pools to the second job based on a second resource allocation for the second job, the second resource allocation indicative of a number of computing resources in the compute cluster allocated for execution of the second job; and sending the selected second resource pool to the job submitter.

In some embodiments, the method further comprises: after sending the selected resource pool to the job submitter, indicating that the selected resource pool is unavailable for selection, and indicating that the selected resource pool is available for selection after receipt of a notification that execution of the job is completed.

In some embodiments, the plurality of resource pools comprises at least one ad hoc resource pool and one or more planned job resource pools, and the job is a planned job, and the selected resource pool is one of the one or more planned job resource pools.

In some embodiments, the method further comprises: receiving, from the job submitter, a job identifier for an unplanned job, and selecting one of the at least one ad hoc resource pool.

In some embodiments, the weight of a resource pool is determined based on a proportion of the quantity of computing resources associated with the resource pool relative to the total quantity of computing resources in the compute cluster.

In some embodiments, the plurality of resource pools is associated with the total number of computing resources in the compute cluster.

In some embodiments, the method further comprises: selecting another resource pool of the plurality of resource pools for the job while the job is being executed and sending the another selected resource pool to the job submitter.

According to another aspect, there is provided a distributed computing system comprising: at least one processing unit; and a non-transitory memory communicatively coupled to the at least one processing unit and comprising computer-readable program instructions executable by the at least one processing unit for: receiving data indicative of a total number of computing resources in a compute cluster of the distributed computing system; generating a plurality of resource pools in accordance with the total number of computing resources, each of the plurality of resource pools associated with a quantity of computing resources that is included in one or more partitions of the total quantity of resources; assigning a weight to each of the plurality of resource pools based on the quantity of computing resources associated with each resource pool; and sending the plurality of resource pools and the weights assigned to each resource pool to a scheduler of the compute cluster.

In some embodiments, the computer-readable program instructions are executable by the at least one processing unit for: receiving, from a job submitter of the computer cluster, a job identifier for a job; selecting a resource pool of the plurality of resource pools for the job based on a resource allocation for the job, the resource allocation indicative of a number of computing resources in the compute cluster allocated for execution of the job; and sending the selected resource pool to the job submitter.

In some embodiments, the sending the selected resource pool to the job submitter comprises sending the selected resource pool to the job submitter for submission to the scheduler, and for the scheduler to assign computing resources in the compute cluster for execution of the job based on the selected resource pool.

In some embodiments, the computer-readable program instructions are executable by the at least one processing unit for: after sending the selected resource pool to the job submitter, indicating that the selected resource pool is unavailable for selection, and indicating that the selected resource pool is available for selection after receipt of a notification that execution of the job is completed.

In some embodiments, the plurality of resource pools comprises at least one ad hoc resource pool and one or more planned job resource pools, and the job is a planned job, and the selected resource pool is one of the one or more planned job resource pools.

In some embodiments, the computer-readable program instructions are executable by the at least one processing unit for: receiving, from the job submitter, a job identifier for an unplanned job, and selecting one of the at least one ad hoc resource pool.

In some embodiments, the weight of a resource pool is determined based on a proportion of the quantity of computing resources associated with the resource pool relative to the total quantity of computing resources in the compute cluster.

In some embodiments, the plurality of resource pools is associated with the total number of computing resources in the compute cluster.

In some embodiments, the computer-readable program instructions are executable by the at least one processing unit for: selecting another resource pool of the plurality of resource pools for the job while the job is being executed and sending the another selected resource pool to the job submitter.

Other features will become apparent from the drawings in conjunction with the following description.

### BRIEF DESCRIPTION OF DRAWINGS

In the figures which illustrate example embodiments,

FIG. 1 is a block diagram of an example distributed computing system;

FIG. 2A is a block diagram of an example resource server;

FIG. 2B is a block diagram of an example computing device;

FIG. 3 is a block diagram of a resource management system, in accordance with an embodiment;

FIG. 4 illustrates an overview of resource enforcement using a fair scheduler, in accordance with an embodiment;

FIG. 5 is a block diagram of components of the resource management system of FIG. 3;

FIG. 6 is a block diagram of the pool pre-creation module provided in the SLA planning unit of FIG. 5;

FIG. 7 illustrates resource partitioning via pool pre-creation, according to an embodiment;

FIG. 8 is a block diagram of the Quality of Service (QoS) identifier generation module provided in the SLA planning unit of FIG. 5;

FIG. 9 illustrates example procedures implemented by the QoS identifier generation module of FIG. 8;

FIG. 10 illustrates an example procedure implemented by the QoS identifier generation module provided in the job submitter of FIG. 5;

FIG. 11 is a block diagram of the resource requirement assignment module of FIG. 5;

FIG. 12 is a block diagram of the planning framework module of FIG. 5;

FIG. 13 is a block diagram of the pool assignment module of FIG. 5;

FIG. 14 illustrates an example of a resource allocation plan, in accordance with an embodiment;

FIG. 15 illustrates the resource allocation plan of FIG. 14 with resource pool assignments, in accordance with an embodiment;

FIG. 16 is a block diagram of the pool identifier module of FIG. 5;

FIG. 17 illustrates an example of enforcement, by way of fair schedulers, of the resource pool definitions as shown in FIG. 15;

FIG. 18 is a block diagram of the execution monitoring module of FIG. 5;

FIG. 19 illustrates a flowchart of resource pool pre-creation, in accordance with an embodiment;

FIG. 20 illustrates a flowchart of an example method for generating and updating resource allocation plans in a compute workflow, in accordance with an embodiment;

FIG. 21 illustrates a flowchart of the steps of FIG. 20 of identifying underlying subtasks for each workflow node and assigning a QoS identifier to each subtask;

FIG. 22 illustrates a flowchart of the step of FIG. 20 of determining a total resource requirement for each subtask;

FIG. 23 illustrates a flowchart of the step of FIG. 20 of generating a resource allocation plan for each node;

FIG. 24 illustrates a flowchart of the step of FIG. 20 of monitoring the actual progress of workload at the workflow orchestration and control system levels;

FIG. 25 illustrates a flowchart of the step of FIG. 20 of updating existing resource allocation plan(s) based on actual resource requirement, as needed;

FIG. 26 illustrates a flowchart of an example procedure implemented at the underlying control system of FIG. 3 to generate QoS identifier, in accordance with an embodiment;

FIG. 27 illustrates a flowchart of an example procedure implemented by a pool assignment module at the SLA planning unit of FIG. 3 to assign a resource pool for a QoS identifier;

FIG. 28 illustrates a flowchart of an example procedure implemented at the job submitter of FIG. 3 to retrieve a resource pool identifier for a QoS identifier;

FIG. 29 illustrates resource assignment for planned job and ad hoc jobs, in accordance with an embodiment;

FIG. 30 illustrates planning a collective down-sizing of running jobs, in accordance with an embodiment;

FIG. 31 illustrates planning a collective up-sizing of running jobs, in accordance with an embodiment;

FIG. 32 illustrates planning with jobs having new pool dependencies, in accordance with an embodiment; and

FIG. 33 illustrates assignment to redundant pools, in accordance with an embodiment.

### DETAILED DESCRIPTION

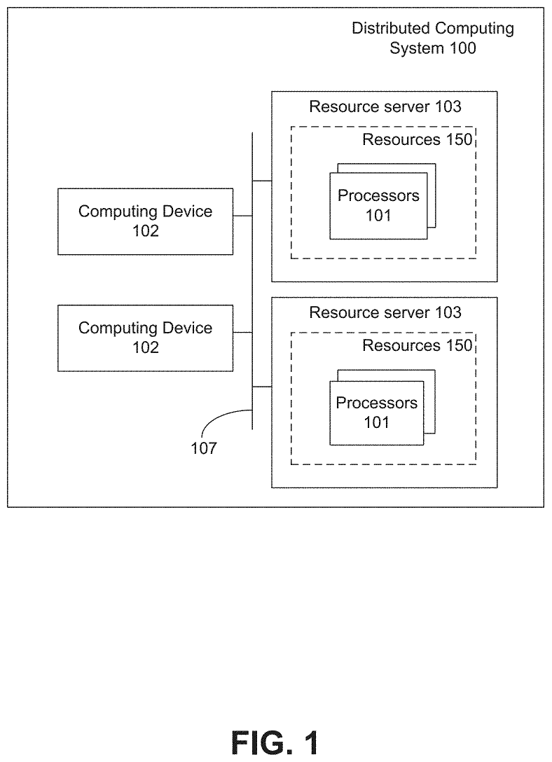

FIG. 1 is a diagram illustrating an example distributed computing system 100. In the distributed computing system 100, one or more computing devices 102 can connect directly or indirectly to one or more resource servers 103 to access or otherwise utilize one or more resources 150 made available by resource servers 103.

The distributed computing system 100 includes hardware and software components. For example, as depicted, distributed computing system 100 includes a combination of computing devices 102 and resource servers 103 connected via network 107. As depicted, resource servers 103 have one or more resources 150 which can be allocated to perform computing workflows from the one or more computing devices 102. Resource servers 103 provide, for example, memory (e.g. Random Access Memory (RAM)), processing units such as processors or processor cores, graphics processing units (GPUs), storage devices, communication interfaces, and the like, individually and collectively referred to herein as resources 150. A collection of computing resources in resources 150 may be referred to as a “compute cluster”. Resources may be logically partitioned into pools of resources of varying sizes, as explained in greater detail below.

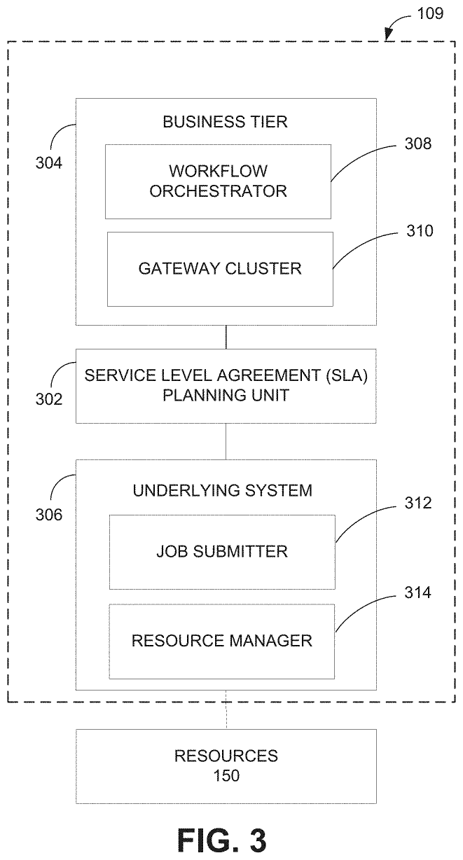

A resource management system 109 (as described in further detail below, and shown in FIG. 3) may be implemented as software, for example, in one or more computing devices 102, and is operable to coordinate the allocation of resources 150 on resource server 103 for the execution of workflows generated by the computing devices 102. In some embodiments, resources 150 include resources from computing devices 102 in addition to resources from resource server 103. In some embodiments, resource server 103 generates workflows for execution by computing resources 150. In some embodiments, resource management system 109 is implemented as a separate hardware device. Resource management system 109 can also be implemented in software, hardware or a combination thereof on one or more of resource servers 103.

The computing devices 102 may include, for example, personal computers, laptop computers, servers, workstations, supercomputers, smart phones, tablet computers, wearable computing devices, and the like. As depicted, the computing devices 102 and resource servers 103 can be interconnected via network 107, for example one or more of a local area network, a wide area network, a wireless network, the Internet, or the like.

The distributed computing system 100 may include one or more processors 101 at one or more resource servers 103. Some resource servers 103 may have multiple processors 101.

In some embodiments, the distributed computing system 100 is heterogeneous. That is, hardware and software components of distributed computing system 100 may differ from one another. For example, some of the computing devices 102 may have different hardware and software configurations. Likewise, some of the resource servers 103 may have different hardware and software configurations. In other embodiments, the distributed computing system 100 is homogeneous. That is, computing devices 102 may have similar hardware and software configurations. Likewise, resource servers 103 have similar hardware and software configurations.

In some embodiments, the distributed computing system 100 may be a single device, physically or logically, such as a single computing device 102 or a single resource server 103 having one or more resources 150. In some embodiments, the distributed computing system 100 may include a plurality of computing devices 102 which are connected in various ways.

Some resources 150 may be physically or logically associated with a single computing device 102 or group of devices, and other resources 150 may be shared resources which may be shared among computing devices 102 and utilized by multiple devices in the distributed computing system 100. That is, some resources 150 can only be assigned to workflows from a subset of computing devices 102, while other resources 150 can be assigned to workflows from any computing device 102. In some embodiments, distributed computing system 100 operates in accordance with sharing policies. Sharing policies are rules which dictate how particular resources are used. For example, resource management system 109 can implement a sharing policy that dictates that workflows from a particular computing device 102 be performed using resources 150 from a particular resource server 103. Sharing policies can be set for a particular type of resource 150 on resource server 103, and can also apply more broadly to all resources on a resource server 103 or apply system-wide. A computing device 102 can also represent a user, a user group or tenant, or a project. Sharing policies can dictate how resources are shared among users, user groups or tenants, or projects.

Resources 150 in the distributed computing system 100 are or can be associated with one or more attributes. These attributes may include, for example, resource type, resource state/status, resource location, resource identifier/name, resource value, resource capacity, resource capabilities, or any other resource information that can be used as criteria for selecting or identifying a resource suitable for being utilized by one or more workloads.

The distributed computing system 100 may be viewed conceptually as a single entity having a diversity of hardware, software and other constituent resources which can be configured to run workloads from the components of distributed computing system 100 itself, as well as from computing devices 102 external to distributed computing system 100.

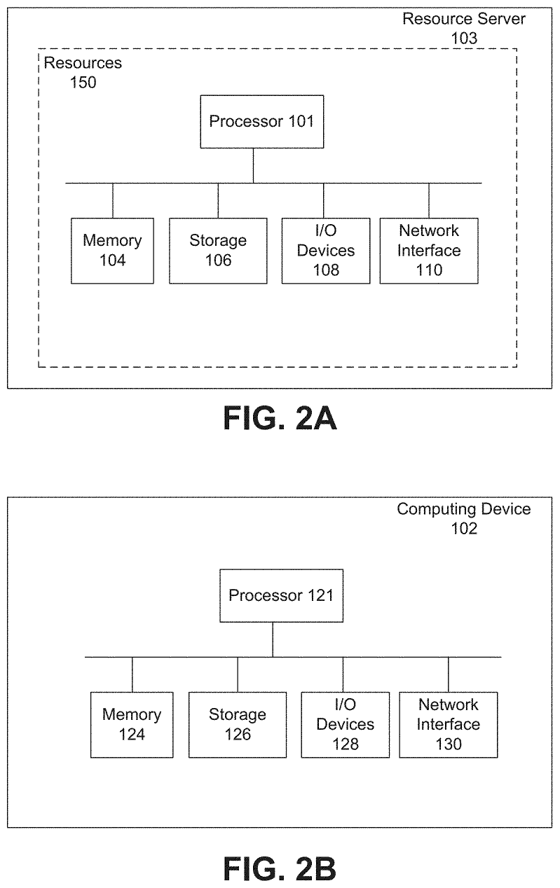

FIG. 2A is a block diagram of an example resource server 103. As depicted, resource server 103 includes one or more processors 101, memory 104, storage 106, I/O devices 108, and network interface 110, and combinations thereof. One or more of the processors 101, memory 104, storage 106, I/O devices 108 and network interface 110 in resource server 103 are used as resources 150 for executing workflows from computing device 102 in distributed computing system 100.

Processor 101 is any suitable type of processor, such as a processor implementing an ARM or x86 instruction set. In some embodiments, processor 101 is a graphics processing unit (GPU). Memory 104 is any suitable type of random-access memory accessible by processor 101. Storage 106 may be, for example, one or more modules of memory, hard drives, or other persistent computer storage devices.

I/O devices 108 include, for example, user interface devices such as a screen, including capacitive or other touch-sensitive screens capable of displaying rendered images as output and receiving input in the form of touches. In some embodiments, I/O devices 108 additionally or alternatively include one or more of speakers, microphones, sensors such as accelerometers and global positioning system (GPS) receivers, keypads or the like. In some embodiments, I/O devices 108 include ports for connecting computing device 102 to other computing devices. In an example, I/O devices 108 include a universal serial bus (USB) controller for connection to peripherals or to host computing devices.

Network interface 110 is capable of connecting computing device 102 to one or more communication networks. In some embodiments, network interface 110 includes one or more of wired interfaces (e.g. wired Ethernet) and wireless radios, such as WiFi or cellular (e.g. GPRS, GSM, EDGE, CDMA, LTE, or the like).

Resource server 103 operates under control of software programs. Computer-readable instructions are stored in storage 106, and executed by processor 101 in memory 104.

FIG. 2B is a block diagram of an example computing device 102. Computing device 102 may include one or more processors 121, memory 124, storage 126, one or more input/output (I/O) devices 128, and network interface 130, and combinations thereof.

Processor 121 is any suitable type of processor, such as a processor implementing an ARM or x86 instruction set. In some embodiments, processor 121 is a graphics processing unit (GPU). Memory 124 is any suitable type of random-access memory accessible by processor 121. Storage 126 may be, for example, one or more modules of memory, hard drives, or other persistent computer storage devices.

I/O devices 128 include, for example, user interface devices such as a screen, including capacitive or other touch-sensitive screens capable of displaying rendered images as output and receiving input in the form of touches. In some embodiments, I/O devices 128 additionally or alternatively include one or more of speakers, microphones, sensors such as accelerometers and global positioning system (GPS) receivers, keypads or the like. In some embodiments, I/O devices 128 include ports for connecting computing device 102 to other computing devices. In an example, I/O devices 128 include a universal serial bus (USB) controller for connection to peripherals or to host computing devices.

Network interface 130 is capable of connecting computing device 102 to one or more communication networks. In some embodiments, network interface 130 includes one or more of wired interfaces (e.g. wired Ethernet) and wireless radios, such as WiFi or cellular (e.g. GPRS, GSM, EDGE, CDMA, LTE, or the like).

Computing device 102 operates under control of software programs. Computer-readable instructions are stored in storage 126, and executed by processor 121 in memory 124.

FIG. 3 is a block diagram of an example resource management system 109. Resource management system 109 includes a business tier 304, a service level agreement (SLA) planning unit 302, an underlying control system 306 and a job submitter 312. Underlying system 306 is communicatively coupled to resources 150. Resources 150 can include resources from one or many resource servers 103. In some embodiments, resources 150 include resources from resource servers 103 and computing devices 102.

Resource management system 109 may ensure Quality of Service (QoS) in a workflow. As used herein, QoS refers to a level of resource allocation or resource prioritization for a job being executed.

Resource management system 109 may be implemented by one or more processors 101 in one or more computing devices 102 or resource servers 103 in the distributed computing system 100. In some embodiments, the resource management system 109 is an infrastructure middleware which can run on top of a distributed computing environment. The distributed environment can include different kinds of hardware and software.

Resource management system 109 handles resource management, workflow management, and scheduling. Workflows can refer to any process, job, service or any other computing task to be run on the distributed computing system 100. For example, workflows may include batch jobs (e.g., high performance computing (HPC) batch jobs), serial and/or parallel batch tasks, real time analytics, virtual machines, containers, and the like. There can be considerable variation in the characteristics of workflows. For example, workflows can be CPU-intensive, memory-intensive, batch jobs (short tasks requiring quick turnarounds), service jobs (long-running tasks), or real-time jobs.

Business tier 304 organizes a plurality of connected computers (referred to generally as compute nodes, not shown) of a computer cluster (not shown) and orchestrates activities on the connected computers. For this purpose, the business tier 304 includes a workflow orchestrator 308 and a gateway cluster 310.

Workflow orchestrator 308 encapsulates business logic (e.g. as specified by a user) into a workflow graph (containing workflow nodes), manages repeatable workloads, and ensures continuous processing. In particular, the actions of workflow orchestrator 308 result in the submission of jobs to be processed by gateway cluster 310, the submitted jobs being in turn divided into one or more underlying subtasks. Examples of workflow orchestrator 308 include, but are not limited to, TCC, Oozie, Control-M, and Azkaban.

Gateway cluster 310 distributes workflow tasks to various underlying systems, such as underlying system 306. In some embodiments, gateway cluster 310 is under the control of workflow orchestrator 308. In other embodiments, gateway cluster 310 is not under the control of workflow orchestrator 308.

Underlying system 306 receives from the business tier 304 the workflow tasks to be processed and accordingly generates its own workload (i.e. a subflow of tasks, often referred to herein as jobs), which is distributed to available compute nodes for execution. Underlying system 306 may comprise systems (referred to herein as control systems) that have QoS features and systems (referred to herein as uncontrolled systems) that cannot be controlled and for which it is desirable to model as requiring zero resources, as will be discussed further below. Examples of control systems include, but are not limited to the native standalone Spark cluster manager on an Apache Spark framework, Yet Another Resource Negotiator (YARN)-based data processing applications. Examples of uncontrolled systems include, but are not limited to, legacy databases, data transfer services, and file system operations.

As depicted, underlying system 306 comprises a job submitter 312 and a resource manager 314.

Job submitter 312 submits jobs and an identifier of an assigned resource pool 520 to resource manager 314, the submitted jobs resulting from action(s) performed by workflow orchestrator 308. Deadlines are typically defined at the workflow level, which in turn imposes strict SLAs (i.e. strict completion deadlines) on some jobs.

Examples of job submitter 312 include, but are not limited to, Hive, Pig, Oracle, TeraData, File Transfer Protocol (FTP), Secure Shell (SSH), HBase, and Hadoop Distributed File System (HDFS).

Resource manager 314 receives jobs submitted by the job submitter 312 and an identifier of an assigned resource pool 520 and distributes the submitted jobs on available compute nodes based on the resources associated with the assigned resource pool 520. The resource manager 314 thereby enforces system resource allocation decisions made by the SLA planning unit 302 on the actual workload, thereby making tasks run faster or slower. The system resources referred to herein include, but are not limited to, Central Processing Unit (CPU) usage, Random Access Memory (RAM) usage, and network bandwidth usage.

It should be understood that the resource manager 314 may be any underlying system that is enabled with a QoS enforcement scheme. As such, the resource manager 314 may comprise, but is not limited to, a scheduler (e.g. YARN, Mesos, Platform Load Sharing Facility (LSF), GridEngine, Kubernetes, or the like), and a data warehouse system enabled with features to enforce QoS (e.g. Relational Database Management System (RDBMS) or the like).

As will be discussed further below, SLA planning unit 302 is an entity that interfaces with the business tier 304 and the underlying system 306 to ensure that jobs within the compute workflow are completed to the specifications and/or requirements set forth by the user (i.e. that the deadlines and SLAs of higher-level workflows are met). For this purpose, SLA planning unit 302 decides the manner in which system resources should be adjusted. In particular, in order to ensure that critical workflows at the business tier level meet their deadlines and SLAs, SLA planning unit 302 chooses the resources to allocate to different tasks, in advance of the tasks being submitted, forming a resource allocation plan for tasks over time. The resource allocation plan identifies, for each task, what resources the task needs, over which period of time. When a task (or job) is received from job submitter 312, SLA planning unit 302 refers to the resource allocation plan is used to identify the resources the job needs, and then a resource pool is identified that can fulfill those resources. The jobs submitter 312, following receipt of the resource pool for the task, transmits the task and assigned resource pool to the resource manager 314 for enforcement on the actual submitted workload. A fair scheduler, as part of resource manager 314, does the enforcement, effectively making sure that resources are divided as planned. In this way, it may be possible to enforce that a task get the planned amount of resources when it runs. It may also be possible to enforce that a task runs when planned for it to run, by SLA planning unit 302 communicating to business tier 304 when to submit tasks. SLA planning unit 302 may also hold tasks for submission at the appropriate time. SLA planning unit 302 may also submit tasks to their assigned resource pools, regardless of whether it is the right time for them to run or not. The resource allocation plan may prevent multiple tasks running in the same resource pool at the same time.

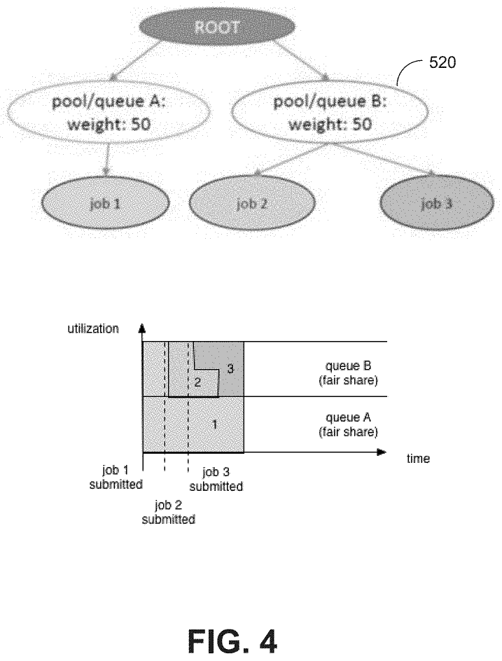

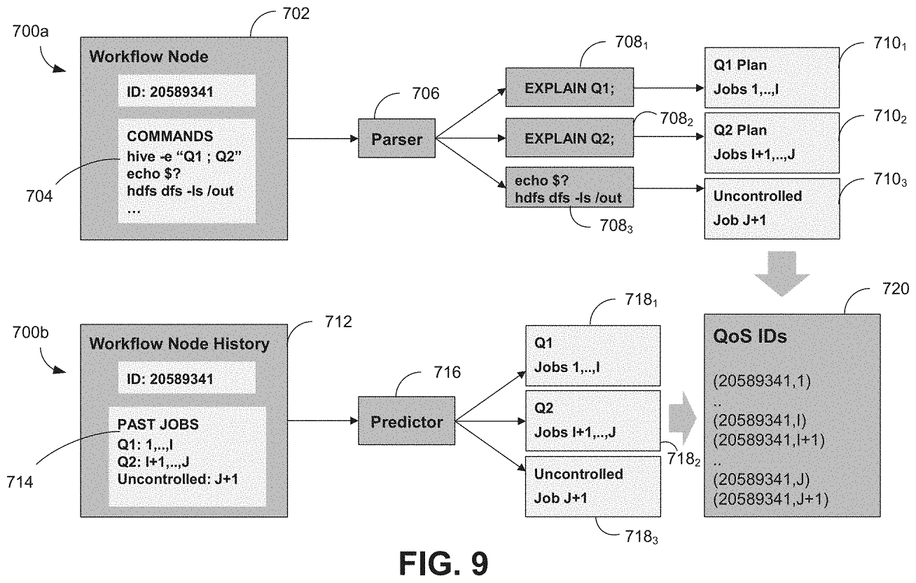

FIG. 4 illustrates an overview of an example of resource enforcement using a fair scheduler (for example, YARN, Apache Spark Scheduler operating in “FAIR” mode where they schedule according to a fair sharing policy). Resource pools 520 have been pre-defined, each with their own weight. As shown in FIG. 4, such resource pools 520 may be a part of or inside of a “root”, which may represent a top-level directory of resource pools 520. During operation, the scheduler will dynamically assign resources to jobs according to the weight of their pool. Each “job” (for example, “job 1”, “job 2” and “job 3” as shown in FIG. 4) may be associated with a QoS identifier. As described in further detail below, SLA QoS identifier generation module 402 generates a unique QoS identifier for each subtask of a given workflow node. A workflow node may represent a unit of work to be done, and may be called a “node” to identify that it is part of a workflow graph of business tier 304. In some embodiments, two parts of a workflow graph may consist of nodes (the vertices) and dependencies (the edges). An example of a workflow node 702 is illustrated in FIG. 9 as described in more detail below.

As shown in FIG. 4, each job is submitted to a pool (or a “queue”) where each resource pool has a weight (or a “priority”). The scheduler assigns resources to resource pools 520 fairly according to weight. Within a resource pool, resources are typically divided by FAIR or FIFO policies. With a FAIR scheduling policy, jobs on average get an equal share of resources over time. A FIFO scheduling policy operates first-in, first-out and jobs are processed in the order that they arrive.

FIG. 4 illustrates a “job 1” assigned to resource pool 520 “A” that has a weight of “50”. “Job 2” and “job 3” are assigned to resource pool 520 “B” that has a weight of “50”. The pool assignments may be performed by way of pool assignment module 407, discussed further below, using a QoS identifier for each job. As shown in the utilization versus time graph, the resources (“utilization”) are split equally between resource pools (“queues”) 520 “A” and “B” on the basis of equal weights of “50”. At a time when “job 1” is submitted, before “job 2” and “job 3” are submitted, the resources of both “A” and “B” are available. When “job 2” is submitted, resources are split 50/50 between “job 1” and “job 2”, as dictated by the relative weights of pools “A” and “B”. When “job 3” is submitted and while “job 2” remains running, resources within pool “B” are split equally between “job 2” and “job 3”, on the basis of fair scheduling within the resource pool. Once “job 2” completes, the entire resources of pool “B” are used by “job 3”.

It should be understood that, although SLA planning unit 302 is illustrated and described herein as interfacing with a single workflow orchestrator 308, SLA planning unit 302 may simultaneously interface with multiple workflow orchestrators. It should also be understood that, although SLA planning unit 302 is illustrated and described herein as interfacing with a single underlying system 306, SLA planning unit 302 may simultaneously interface with multiple underlying systems.

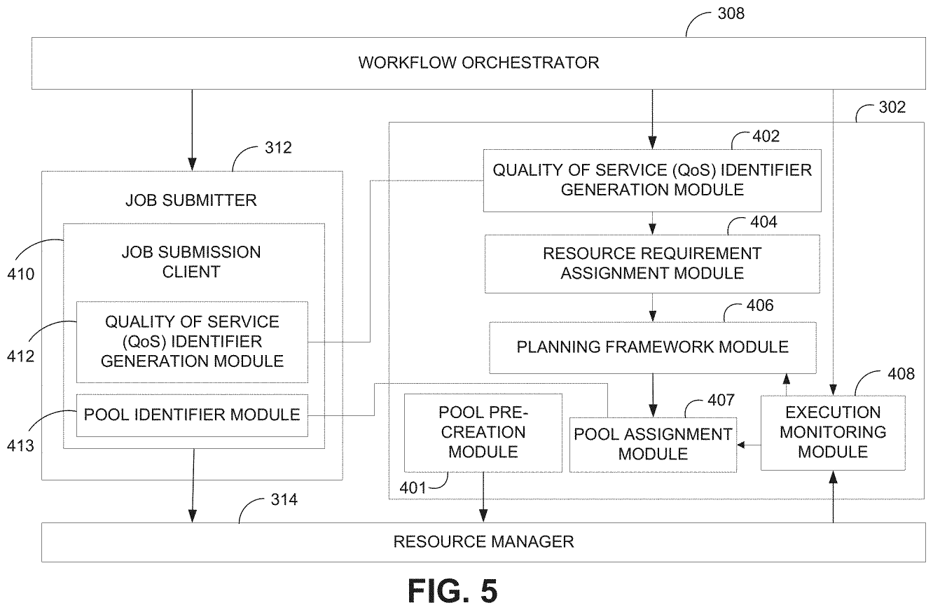

FIG. 5 illustrates an example embodiment of SLA planning unit 302. SLA planning unit 302 includes a pool pre-creation module 401, an SLA QoS identifier generation module 402, a resource requirement assignment module 404, a planning framework module 406, a pool assignment module 407, and an execution monitoring module 408. Job submitter 312 includes a job submission client 410, which in turn comprises a QoS identifier generation module 412 and a pool identifier module 413.

As will be discussed in further detail below, pool pre-creation module 401 provided in SLA planning unit 302, for a given number of resources to partition in cluster, runs a resource partitioning algorithm to define resource pools 520. A defined resource pool 520 is a partition of resources 150. Prior to running workflow, resource manager 314 of underlying system 306 is initialized with the defined resource pools via resource partitioning.

As will be discussed further below, SLA QoS identifier generation module 402 provided in the SLA planning unit 302 discovers, for each workflow node, the underlying system (e.g. YARN) jobs, referred to herein as subtasks, which are associated with the node and which will be submitted by the underlying system job submitter 312. The SLA planning unit 302 also discovers the dependencies between the underlying subtasks. The SLA QoS identifier generation module 402 then generates a unique QoS identifier for each subtask of a given node.

QoS identifier generation module 412 provided in the job submission client 410 runs a complementary procedure that generates the same QoS identifiers as those generated by the SLA QoS identifier generation module 402 for planned workflow nodes. As used herein, the term QoS identifier refers to a credential used by a user of a controllable system to reference the level of QoS that they have been assigned.

Pool identifier module 413 provided in job submission client 410 uses QoS identifiers to retrieve an assigned resource pool. In some embodiments, a submit time is also retrieved, defining a time at which to submit job to scheduler pool. The submit time may be defined as the planned job start time.

Resource requirement assignment module 404 determines and assigns a resource requirement for each subtask of the given node and planning framework module 406 accordingly generates a resource allocation plan for each subtask having a resource requirement and a QoS identifier. As used herein, the term resource requirement refers to the total amount of system resources required to complete a job in underlying system 306 as well as the number of pieces the total amount of resources can be broken into in the resource and time dimension. The term resource allocation plan refers to the manner in which required system resources are distributed over time.

Pool assignment module 407, upon receipt of a QoS identifier for a job from job submitter 312, determines and assigns a resource pool for that QoS identifier from the defined resource pools.

A resource pool 520 is selected for the job from the defined resource pools 520 based on a resource allocation for the job, the resource allocation indicative of a number of computing resources in the compute cluster allocated for execution of the job. The selected resource pool 520 is then sent to the job submitter.

Execution monitoring module 408 monitors the actual progress of the workload at both the workflow orchestration and the underlying system levels and reports the progress information to planning framework module 406 and pool assignment module 407. Using the progress information, planning framework module 406 dynamically adjusts previously-generated resource allocation plans as needed in order to ensure that top-level deadlines and SLAs are met.

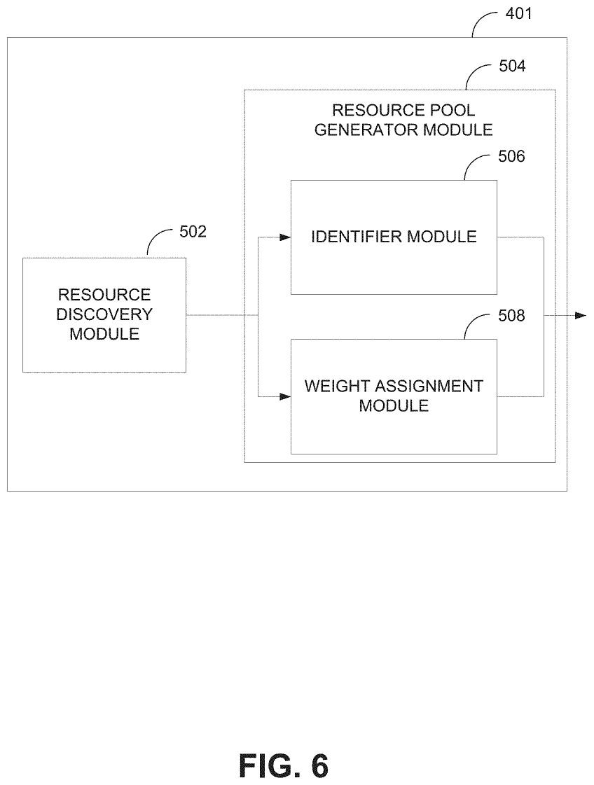

Referring now to FIG. 6, a block diagram of the pool pre-creation module provided in the SLA planning unit of FIG. 5 is shown. Pool pre-creation module 401 includes a resource discovery module 502 and a resource pool generator module 504, which may further include an identifier module 506 and a weight assignment module 508.

Resource discovery module 502 identifies resources 150 within distributed computing system 100, or within a compute cluster of distributed computing system 100. Resource pool generator module 504 receives the identified resources to define resource pools 520. Identifier module 506 assigns a resource pool identifier to each resource pool, and weight assignment module 508 assigns weight to each resource pool 520, based on the quantity of computing resources associated with that resource pool.

To define resource pools 520, the identified resources within distributed computing system 100 are partitioned, as a complete dividing up of the resources into resource pools. Together, the resource pools 520 define all the available resources 150, or a defined subset or compute cluster of available resources. Different jobs may execute to use different resource pools 520.

Thus, prior to scheduling, resource pools 520 are pre-created to support, in an example, all possible partitions of resources. The defined resource pools may be associated with the total number of computing resources in the compute cluster.

The defined resource pools 520 are sent to resource manager 314 of underlying system 306, to initialize with the defined resource pools.

In an example, a resource cluster with five cores can support five jobs running in parallel with one core each, by pre-creating five pools of equal weight (e.g., weight equal to one) without loss of generality. Or, the cluster can support one job with one core, and two jobs with two cores each, by pre-creating the appropriate pools of weight 1, 2 and 2. The total number of resource pools needed to be pre-created to support any combination of resource sharing grows as the “divisor summatory function” and is tractable up to a very large number of resources (e.g., with 10,000 cores, 93,668 different pools are needed). To take advantage of the pre-created pools, resource planning is done, as described below, and new jobs are dynamically submitted to resource pools that correspond to how many resources the jobs are planned to use. The fair scheduler itself does the enforcement, effectively making sure resources are divided according to plan.

In an example, the available resources may be a set of cores that jobs can use, for example a cluster with 32 cores. A partition of 32 cores into parts, or resource pools 520, could be two resources pools 520, one with 2 cores, the other with 30 cores. A job running in a 2-core resource pool has less resources than a job running in a 30-core resource pool 520. A partition of 32 cores in an alternative may be three resource pools 520, each pool with 10 cores. As another example, a partition of 6 cores into resource pools 520 could be “1” and “5”, or “2” and “4”, or “3”, “1” and “2”, or “1”, “1”, “1”, “1”, “1” and “1”, or other suitable arrangement.

Weight assignment module 508, in assigning weight to each resource pool 520, sets the “weight” of the pool to be, in an example, the number of cores in the pool. To distinguish pools of the same weight, identifier module 506 may index them. In an example, resource pools 520 may be identified based on the weight of the pool and an index number. In an example, three pools of weight “1” (for, e.g., 1-core pools), may be identified as follows: 1#1, 1#2, 1#3. Other logically-equivalent identifiers may also be used.

The “weight” as used herein may be understood as the fair scheduling weight used for resource enforcement when using fair schedulers. During operation, a fair scheduler will dynamically assign resources to jobs according to the weight of the assigned resource pool 520. Many schedulers (including YARN and Apache Spark Scheduler) have a “FAIR” mode where they schedule according to a fair scheduling policy. Within a resource pool 520, resources are typically divided by FAIR or FIFO policies. The weight of a resource pool 520 may be determined based on a proportion of the quantity of computing resources associated with the resource pool relative to the total quantity of computing resources in the compute cluster.

Partitioning and pre-defining, in an example, six pools of one core each, may be identified as 1#1, 1#2, 1#3, 1#4, 1#5 and 1#6. In use, jobs may be run in each of the resource pools 520 simultaneously, such that each job uses one of the six cores, according to a fair sharing policy.

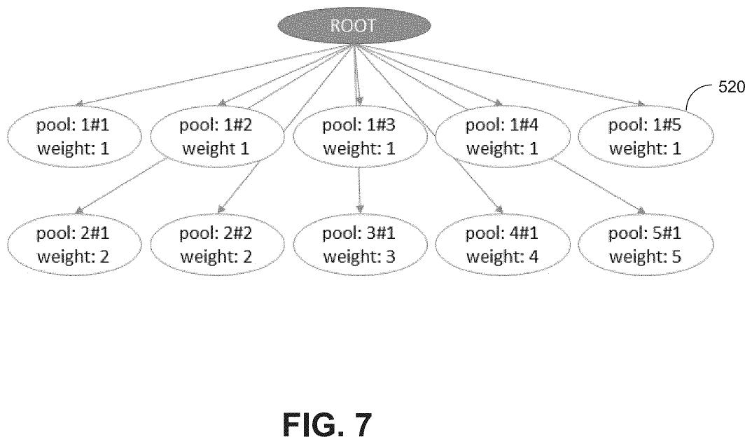

In the example above, six resource pools 520 of one core each may be used. However, in other partitions, all six one-core resources pools 520 may not be needed. Other possible partitionings of six cores that can occur in practice include at most, three resource pools 520 of 2 cores each (2#1, 2#2 and 2#3), at most two resource pools 520 of three cores each (3#1 and 3#2), at most one resource pool 520 of 4 cores (4#1), at most one resource pool 520 of 5 cores (5#1) and at most one resource pool 520 of 6 cores (6#1). In the case of one resource pool 520 of 6 cores, the whole cluster of resources would be used by one job, as the pool spans all the cores in the resources. A full pool definition for a 6-core case includes defining all the pools with all their associated weights, to cover all possible resources partitionings. An example is shown in FIG. 7.

FIG. 7 illustrates resource partitioning via pool pre-creation by pool pre-creation module 401. Prior to a scheduler in underlying system 306 starting, resource pools 520 are created to support all possible partitions of resources 150. In the example shown in FIG. 7, the cluster of resources 150 has 5 cores. Resources pools 520 are pre-created to enable all partitions of 5 cores. With these resources pools 520, it is possible to support five jobs running in parallel using 1 core each (1,1,1,1,1) by submitting jobs to pool 1#1, 1#2, 1#3, 1#4 and 1#5, or support one job using 1 core and two more using 2 cores each (1,2,2) by submitting jobs to pools 1#1, 2#1 and 2#2, and so on, up to seven possible combination. The set of pre-created pools defines the resources pools 520.

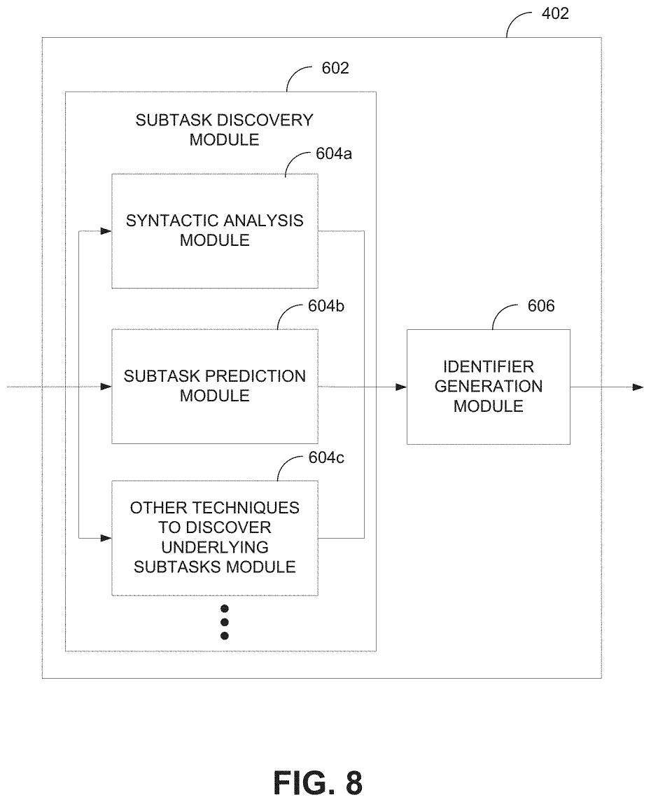

Referring now to FIG. 8, SLA QoS identifier generation module 402 includes a subtask discovery module 602, which may comprise one or more submodules 604a, 604b, 604c, . . . SLA QoS identifier generation module 402 further comprises an identifier generation module 606. SLA QoS identifier generation module 402 receives from the workflow orchestrator 308 input data that is processed to generate a workflow graph with QoS identifiers. The input data may be pushed by the workflow orchestrator 308 or pulled by SLA planning unit 302. The input data indicates the number of workflow nodes to plan, the dependencies between the workflow nodes, as well as metadata for each workflow node. The metadata includes, but is not limited to, an identifier (W) for each node, deadlines or earliest start times for the node, and commands that the node will execute on the gateway cluster 310. In some embodiments, the metadata comprises a resource requirement estimate for the node. The input data is then processed by the subtask discovery module 602 to identify the underlying subtasks associated with each workflow node.

Subtask discovery module 602 identifies underlying subtasks for a given workflow node using various techniques, which are each implemented by a corresponding submodule 604a, 604b, 604c, . . . . In one embodiment, a syntactic analysis module 604a is used to syntactically analyze the commands executed by the node to identify commands that impact operation of the underlying system 306. Syntactic analysis module 604a then sequentially assigns a number (N) to each command. This is illustrated in FIG. 9, which shows an example of a subtask discovery procedure 700a performed by syntactic analysis module 604a. In subtask discovery procedure 700a, workflow node 702, whose identifier (W) is 20589341, executes a set of commands 704. Commands 704 are sent to a parser 706 (e.g. the query planner from Hive), which outputs a set of queries Q1, Q2 . . . , which are then encapsulated into suitable commands (e.g. the EXPLAIN command from Hive) 708₁, 708₂, 708₃ to discover the corresponding underlying subtasks 710₁, 710₂, 710₃. The underlying subtasks are then sequenced from 1 to J+1.

In another embodiment, in order to identify underlying subtasks for a given workflow node, a subtask prediction module 604b is used. Subtask prediction module 604b uses machine learning, forecasting, or other suitable statistical or analytical techniques to examine historical runs for the given workflow node. Based on prior runs, subtask prediction module 604b predicts the subtasks that the node will execute and assigns a number (N) to each subtask. This is illustrated in FIG. 9, which shows an example of a subtask discovery procedure 700b performed by the subtask prediction module 604b. In the procedure 700b, the subtask prediction module 604b examines the workflow node history 712, which comprises a set of past jobs 714 executed by the workflow node 702 having identifier (W) 20589341. A predictor 716 is then used to predict the underlying subtasks 718₁, 718₂, 718₃ that will be executed by the workflow node 702. Underlying subtasks 718₁, 718₂, 718₃ discovered by procedure 700b (i.e. using subtask prediction module 604b) are the same as the underlying subtasks 710₁, 710₂, 710₃ discovered by the subtask discovery procedure 700a (i.e. using syntactic analysis module 604a). It should however be understood that various techniques other than syntactic analysis and prediction may be used to discover underlying subtasks for each workflow node (as illustrated by module 604c). For example, a user may provide his/her guess as to what the underlying subtasks will be and the SLA QoS identifier generation module 402 may receive this information as input. Other embodiments may apply.

As can be seen in FIG. 9, for any given workflow node, the underlying subtasks comprise controlled subtasks (710₁, 710₂ or 718₁, 718₂), which are associated with dependent QoS-planned jobs. The underlying subtasks also comprise uncontrolled subtasks (710₃ or 718₃), which are associated with workflow nodes that cannot be controlled (also referred to as opaque or obfuscated workflows). Uncontrolled subtasks may be created at business tier 304, but are assigned zero resources in underlying system 306. However, because controlled subtasks may depend on uncontrolled subtasks, uncontrolled subtasks are included in a resource allocation plan generated by SLA planning unit 302. As will be discussed further below, SLA planning unit 302 models uncontrolled work by its duration only and assigns zero resources to uncontrolled work. In this manner, even though resources may be available for work dependent on the uncontrolled subtasks, the dependent work is required to wait for expiry of the duration before beginning.

Once the underlying subtasks have been discovered for a given workflow node, the identifier generation module 606 generates and assigns a unique QoS identifier to each subtask, including uncontrolled subtasks. In one embodiment, the pair (W, N) is used as the QoS identifier, which comprises the identifier (W) for each node and the number (N) assigned to each underlying subtask for the node. This is shown in FIG. 9, which illustrates that, for both subtask discovery procedures 700a and 700b, the QoS identifiers 720 are generated as a pair comprising the node identifier 20589341 and the subtask number (1, . . . , J+1). Identifier generation module 606 then outputs a graph of workflow nodes including the generated QoS identifier for each workflow node. In particular, by generating dependencies between underlying subtasks identified by subtask discovery module 602, identifier generation module 606 expands on the workflow graph provided by workflow orchestrator 308.

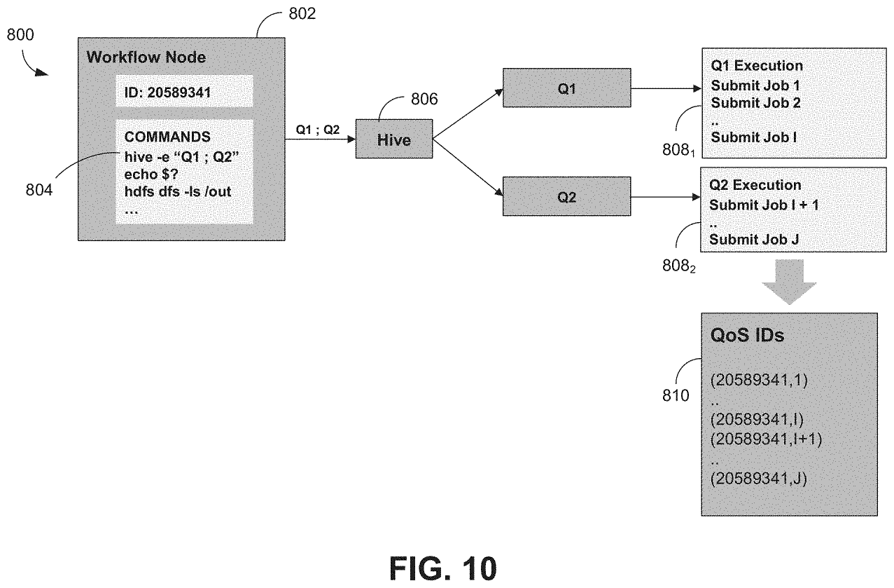

As discussed above and illustrated in FIG. 10, the QoS identifier generation module 412 provided in the job submission client 410 implements a procedure 800 to replicate the QoS identifier generation procedure implemented by the SLA QoS identifier generation module 402. The QoS identifier generation module 412 accordingly generates QoS identifiers for submitted jobs associated with a given workflow node 802 (having identifier (W) 20589341). In the example procedure 800, the commands 804 for node 802 are sent to a Hive query analyzer 806, which outputs queries Q1 and Q2, which are in turn respectively executed, resulting in two sets of jobs 808₁ (numbered 1 to I), 808₂ (numbered I+1 to J) being submitted for both queries. The QoS identifiers 810 are then generated by observing the order of (e.g. counting) the submitted jobs, determining the number (N, with N=1, . . . , J in FIG. 10) of each submitted job, and using the pair (W, N) as the QoS identifier. It will be readily understood that the QoS identifier generation module 412 provided in the job submission client 410 provides QoS identifiers for controlled jobs only and does not take uncontrolled jobs into consideration. It will also be understood that the QoS identifier generation module 412 generates QoS identifiers 810, which are the same as the QoS identifiers 720 generated by the SLA QoS identifier generation module 402 for controlled jobs (1, . . . , J). Once generated, the QoS identifiers 810 are used by pool identifier module 413 to obtain an assigned resource pool 520 to that particular QoS identifier 810, and QoS identifiers 810 and an identifier of resource pool 520 is attached to the workload submitted to resource manager 314, as described in further detail below.

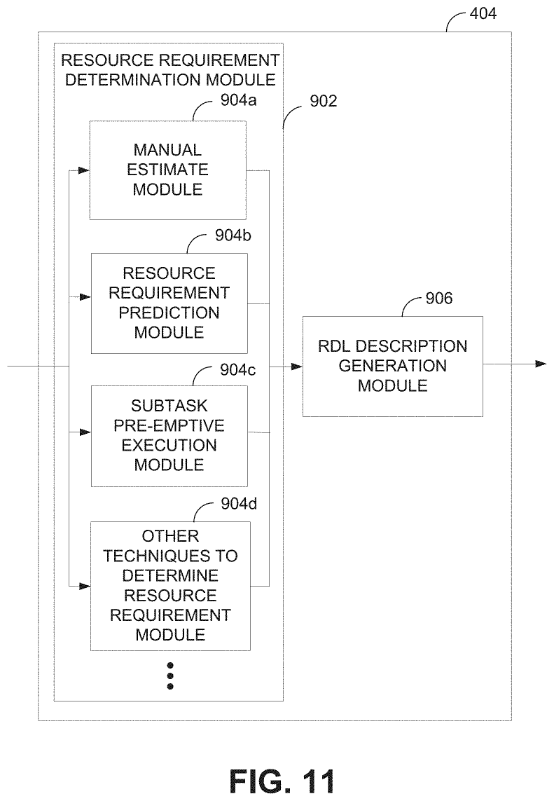

Referring now to FIG. 11, resource requirement assignment module 404 comprises a resource requirement determination module 902, which may comprise one or more submodules 904a, 904b, 904c, 904d, . . . . In particular, resource requirement assignment module 404 determines the resource requirement for each subtask using various techniques, which are each implemented by a corresponding one of submodules 904a, 904b, 904c, 904d, . . . . Resource requirement assignment module 204 further comprises a reservation definition language (RDL) description generation module 906. Resource requirement assignment module 404 receives from SLA QoS identifier generation module 402 the graph of workflow nodes with, for each workflow node, metadata comprising the QoS identifier generated for the node. In some embodiments, the metadata comprises an overall resource requirement estimate for the node, as provided by a user using suitable input means. In this case, resource requirement determination module 902 uses a manual estimate module 904a to divide the overall resource requirement estimate uniformly between the underlying subtasks for the node.

In embodiments where no resource requirement estimate is provided, resource requirement determination module 902 uses a resource requirement prediction module 904b to obtain the past execution history for the node and accordingly predict the resource requirement of each subtask. In other embodiments, resource requirement determination module 902 uses a subtask pre-emptive execution module 904c to pre-emptively execute each subtask over a predetermined time period. Upon expiry of the predetermined time period, subtask pre-emptive execution module 904c invokes a “kill” command to terminate the subtask. Upon terminating the subtask, subtask pre-emptive execution module 904c obtains a sample of the current resource usage for the subtask and uses the resource usage sample to model the overall resource requirement for the subtask. For subtasks that were flagged as uncontrolled by SLA QoS identifier generation module 402, resource requirement determination module 902 sets the resource usage dimension of the resource requirement to zero and only assigns a duration. It should be understood that, in order to determine and assign a resource requirement to each subtask, techniques other than manual estimation of the resource requirement, prediction of the resource requirement, and pre-emptive execution of subtasks may be used (as illustrated by module 904d).

RDL description generation module 906 then outputs a RDL description of the overall workflow to plan. The RDL description is provided as a workflow graph that specifies the total resource requirement for each subtask (i.e. the total amount of system resources required to complete the subtask, typically expressed as megabytes of memory and CPU shares) as well as the duration of each subtask. The RDL description further specifies that uncontrolled subtasks only have durations, which must elapse before dependent tasks can be planned. In this manner and as discussed above, it is possible for some workflow nodes to require zero resources from the underlying compute cluster yet have a duration that should elapse before a dependent job can run.

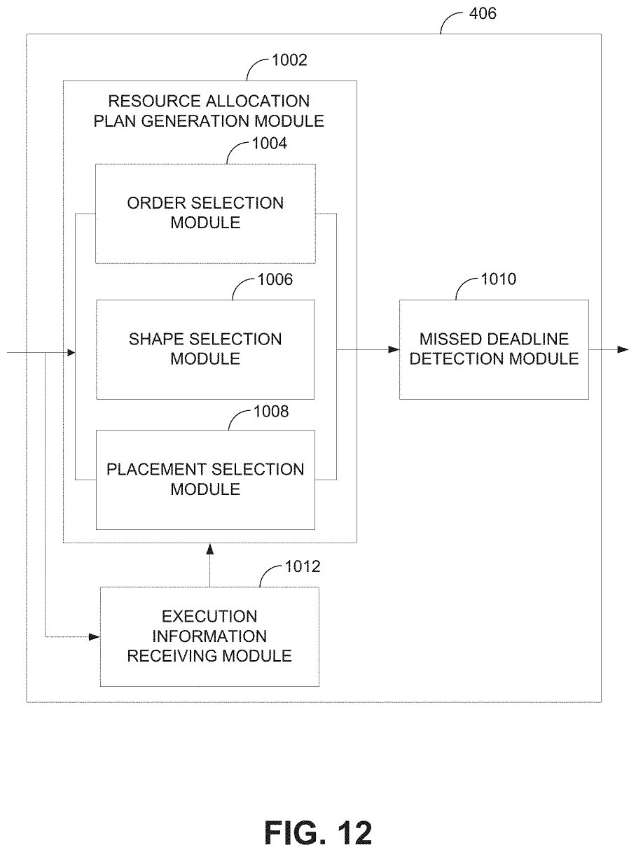

Referring now to FIG. 12, planning framework module 406 comprises a resource allocation plan generation module 1002, which comprises an order selection module 1004, a shape selection module 1006, and a placement selection module 1008. Planning framework module 406 further comprises a missed deadline detection module 1010 and an execution information receiving module 1012. Planning framework module 406 receives from resource requirement assignment module 404 a graph of workflow nodes (e.g. the RDL description) with metadata for each workflow node. The metadata comprises the QoS identifier generated by the SLA QoS identifier generation module 402 for each workflow node, the resource requirement assigned to the node by resource requirement assignment module 404, and a capacity of the underlying system (as provided, for example, by a user using suitable input means). In some embodiments, the metadata comprises the deadline or minimum start time for each workflow node (as provided, for example, by a user using suitable input means).

The planning framework module 406 then generates, for each workflow node in the RDL graph, a resource allocation plan for each subtask of the node using the resource allocation plan generation module 1002. The resource allocation plan specifies the manner in which the resources required by the subtask are distributed over time, thereby indicating the level of QoS for the corresponding workflow node. The order selection module 1004 chooses an order in which to assign resource allocations to each subtask. The shape selection module 1006 chooses a shape (i.e. a resource allocation over time) for each subtask. The placement selection module 1008 chooses a placement (i.e. a start time) for each subtask. In one embodiment, each one of the order selection module 1004, the shape selection module 1006, and the placement selection module 1008 makes the respective choice of order, shape, and placement heuristically. In another embodiment, each one of the order selection module 1004, the shape selection module 1006, and the placement selection module 1008 makes the respective choice of order, shape, and placement in order to optimize an objective function. In yet another embodiment, each one of the order selection module 1004, the shape selection module 1006, and the placement selection module 1008 makes the respective choice of order, shape, and placement in a random manner. In yet another embodiment, the jobs that are on the critical path of workflows with early deadlines are ordered, shaped, and placed, before less-critical jobs (e.g. jobs that are part of workflows with less-pressing deadlines). It should also be understood that the order selection module 1004, the shape selection module 1006, and the placement selection module 1008 may operate in a different sequence, e.g. with shape selection happening before order selection. Moreover, the different modules may operate in an interleaved or iterative manner.

As discussed above, in some embodiments, the deadline or minimum start time for each workflow node is provided as an input to the planning framework module 406. In this case, for each workflow node, the missed deadline detection module 1010 determines whether any subtask has violated its deadline or minimum start time. The missed deadline detection module 1010 then returns a list of subtasks whose deadline is not met.

The missed deadline detection module 1010 further outputs the resource allocation plan and the quality of service identifier associated with each subtask to resource pool assignment module 407.

It should be understood that the SLA planning unit 302 may manage multiple resource allocation plans within a single workflow orchestrator 308 or underlying system instance (for multi-tenancy support for example). It should also be understood that SLA planning unit 302 may also provide the resource allocation plan to the workflow orchestrator 308. In this case, SLA planning unit 302 may push the resource allocation plan to the workflow orchestrator 308. The resource allocation plan may alternatively be pulled by the workflow orchestrator 308. For each workflow node, the workflow orchestrator 308 may then use the resource allocation plan to track the planned start times of each subtask, or wait to submit workflows until their planned start times.

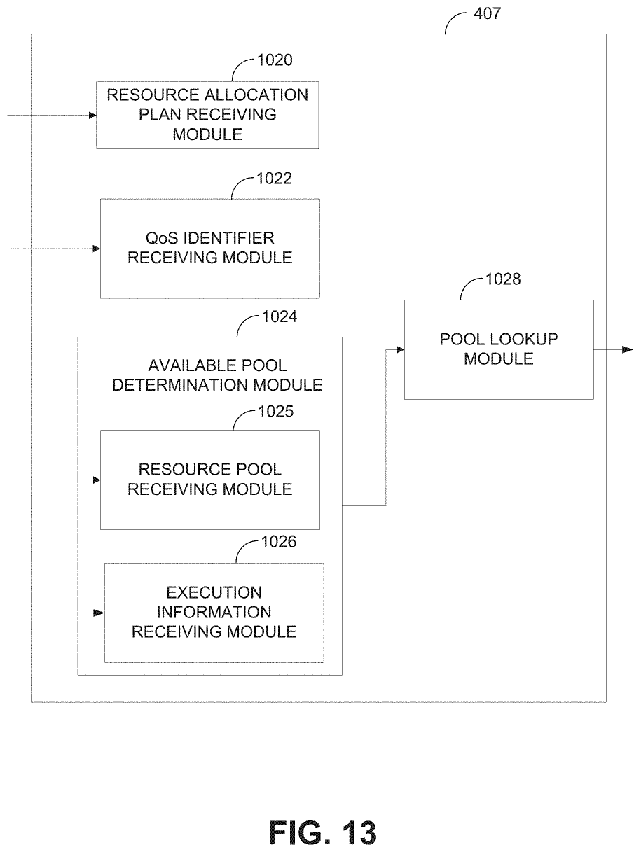

FIG. 13 is a block diagram of pool assignment module 407. Pool assignment module 407 waits for jobs to be submitted with the same QoS identifiers as the QoS identifiers associated with the planned workflow nodes (as per the resource allocation plan).

Pool assignment module 407 acts as bookkeeping to keep track of which resource pools 520 of a desired weight are in use at any moment in time, so that new jobs can always go into unused pools of the appropriate weight. Pool assignment module 407 takes QoS identifier as input, looks up its requested resource size in the resource allocation plan, and then finds a resource pool 520 that can satisfy that resource requirement, and then return an identifier of the corresponding resource pool 520 as output.

Resource allocation plan receiving module 1020 receives the resource allocation plan info from planning framework module 406. QoS identifier receiving module 1022 receives the QoS identifier from pool identifier module 413 of the job that a resource pool is assigned to.

Pool assignment module 407 then determines available resource pools. Receiving module 1025 receives the defined resource pools 520 from pre-creation module 401. Execution information receiving module receives execution info from execution monitoring module 408. In this way, available pool determination module 1024 may maintain a record of available pools that are not in use. Pool assignment module 407 may also update the record of available pools, based on data received from execution monitoring module 408.

Pool lookup module 1028 then identifies an available pool to fulfill the requirements as dictated by the resource allocation plan. In some embodiments, the selected resource pool 520 is associated with a quantity of computing resources to which another job has not been assigned.

Pool assignment module 407 then sends an identifier of the assigned resource pool 520 to pool identifier module 413 of job submitter 312.

In some embodiments, after sending the selected resource pool 520 to job submitter 312, pool assignment module 407 indicates that the selected resource pool is unavailable for selection. After receiving notification that execution of the job is completed from execution monitoring module 408, pool assignment module indicates that the selected resource pool is available for selection.

In this way, each job, identified by a QoS identifier, is assigned a resource pool 520. Logically, each resource pool 520 may be identified by an identifier corresponding to a unique weight and weight index, for example, in the format “pool_weight#index”. When each job finishes on a cluster, as indicated by execution monitoring module 408, the record of available pools is updated.

In an example of a pool assignment, resource pool receiving module 1025 may be initialized with the defined resource pools 520. For every weight, a list may be created of all resource pools 520 available for that weight. For example, for eight total resources, the available pools of weight “2” may be identified as [2#1, 2#2, 2#3, 2#4]. A stack or queue may be used as the structure to identify those available pools, and may permit fast insertion and retrieval/deletion.

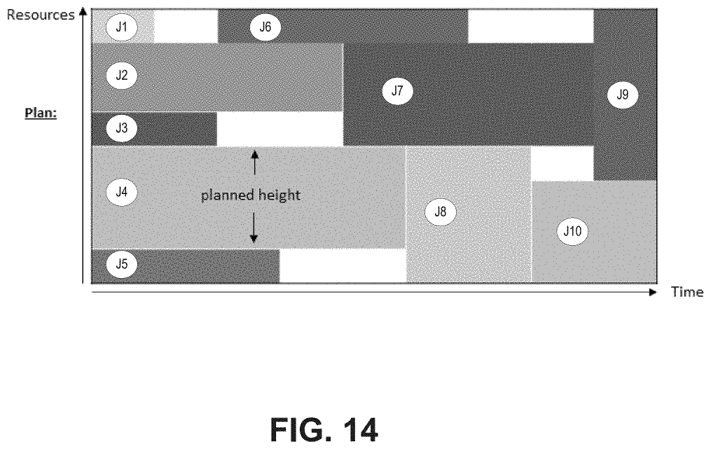

FIG. 14 illustrates an example of a resource allocation plan generated by resource allocation plan generation module 1002 of planning framework module 406. Each shape represents the resource allocation (“planned height”) and duration over time for the current subtask (or “job”), “J”, illustrated in FIG. 14. FIG. 14 illustrates ten jobs identified as “J1” to “J10”. While FIG. 14 uses rectangles to illustrate the planned shapes for each job, it should be understood that other shapes can be used in practice.

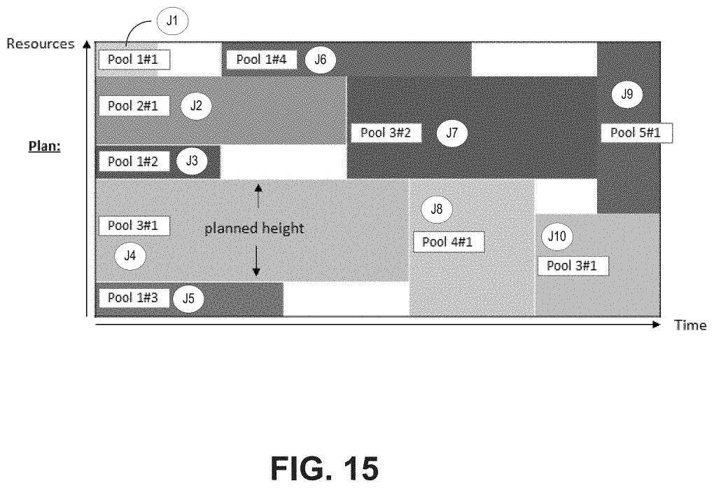

FIG. 15 illustrates the resource allocation plan of FIG. 14 with resource pool assignments. For each subtask, before the subtask starts running, a weight is retrieved from the resource allocation plan, and an available resource pool is retrieved from the corresponding queue, for example, “pool_id=available_pools[w].dequeue”. The example pool assignments are shown, for example “Pool 1#1”, in FIG. 15. When each subtask finishes running, the pool_id for the finished subtask is added back to the available pool list, for example “available_pools[w].enqueue(pool_id)”.

This pool assignment may be performed online (as subtasks start or finish in real-time, and subtask status info is received from the execution monitoring module), or may be run “forward” logically, using the current resource allocation plan (without relying on subtask status information from the execution monitoring module), as needed. Performing pool assignment online may accommodate subtasks finishing earlier or later than expected.

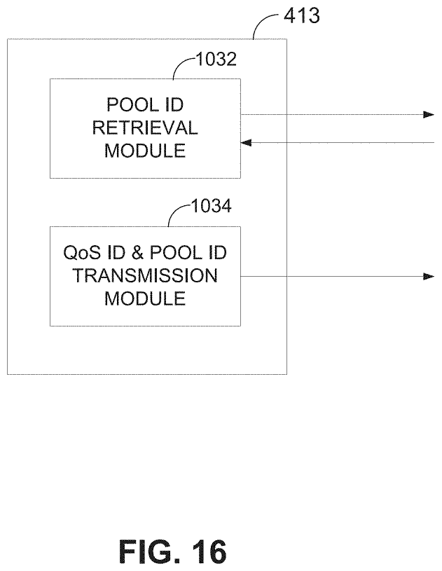

FIG. 16 is a block diagram of pool identifier module 413. Pool ID retrieval module 1032 sends a QoS identifier to pool assignment module 407, and receives a resource pool identifier for that QoS identifier.

QoS identifier and its associated pool identifier are then sent by QoS ID and Pool ID transmission module 1034 to resource manager 314 of underlying system 306.

In some embodiments, pool identifier module 413 may retrieve a start time for a QoS identifier from pool assignment module 407. In other embodiments, the start times may be retrieved from the planning framework module 406. Planned start times may also be optional. Use of a planned start time may increase the efficiency of use of resources in the distributed computing system 100. The planned start time may not need to be precisely timed if the scheduler is configured to use a first in, first out policy within a resource pool.

QoS identifiers 810 and the assigned resource pool 520 identifiers are attached to the workload submitted to resource manager 314.

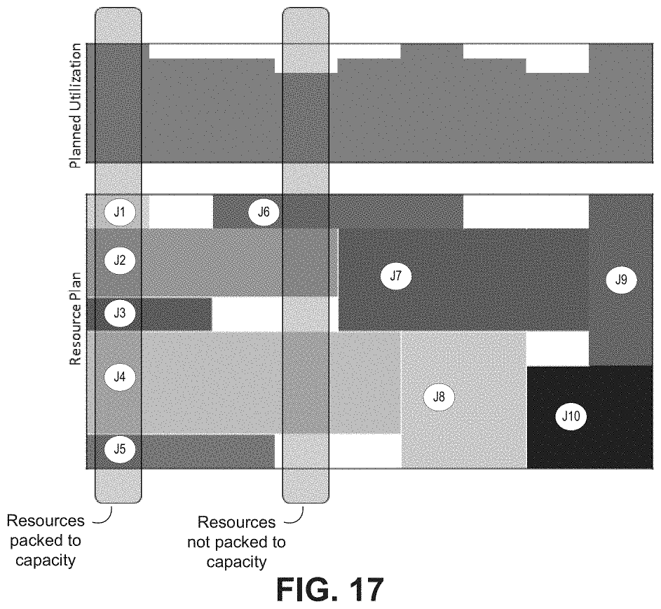

FIG. 17 illustrates an example of enforcement, by way of fair schedulers, of the resource pool definitions as shown in FIG. 15 (resource pool identifiers omitted in FIG. 17). Given the pool definitions, the scheduler will enforce that subtasks in the pool get their share of the cluster resources. Jobs are submitted to their assigned pools, and the fair scheduler ensures that jobs get at least their assigned share of resources.

As shown in FIG. 17, when resources are packed to capacity (at one hundred percent utilization), the fair scheduler and pool weights may guarantee that subtasks get their planned allocated share of resources. When resources are not packed to capacity, jobs will fairly share the free resources in proportion to their pool weights.

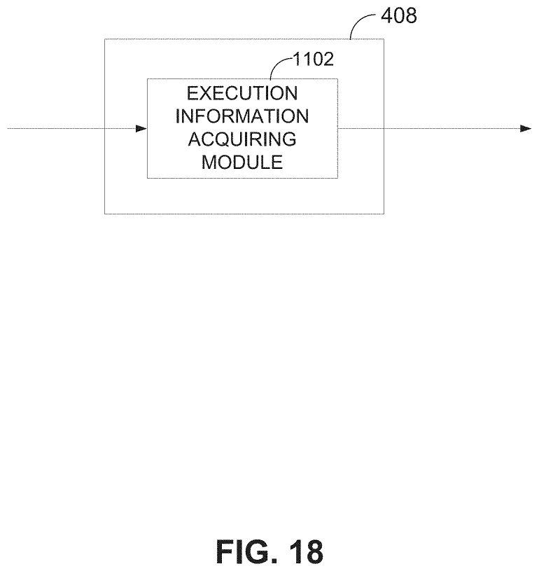

Referring now to FIG. 18, execution monitoring module 408 is used to monitor the actual workload progress at both the workflow orchestration and underlying system levels. For this purpose, execution monitoring module 408 comprises an execution information acquiring module 1102 that obtains execution status information from workflow orchestrator 308 and resource manager 314. In one embodiment, execution information acquiring module 1102 retrieves (e.g. pulls) the execution information from workflow orchestrator 308 and resource manager 314. In another embodiment, workflow orchestrator 308 and resource manager 314 send (e.g. push) the execution information to execution information acquiring module 1102. The execution status information obtained from workflow orchestrator 308 includes information about top-level workflow node executions including, but not limited to, actual start time, actual finish time, normal termination time, and abnormal termination time. The execution status information obtained from resource manager 314 includes information about underlying system jobs including, but not limited to, actual start time, actual finish time, percentage of completion, and actual resource requirement.

Once execution monitoring module 408 determines the actual workload progress, execution information acquiring module 1102 sends the execution information to planning framework module 406. The execution information is then received at the execution information receiving module 1012 of planning framework module 406 and sent to resource allocation plan generation module 1002 so that one or more existing resource allocation plans can be adjusted accordingly. Adjustment may be required in cases where the original resource requirement was incorrectly determined by the resource requirement assignment module 404. For example, incorrect determination of the original resource requirement may occur as a result of incorrect prediction of the subtask requirement. Inaccurate user input (e.g. an incorrect resource requirement estimate was provided) can also result in improper determination of the resource requirement.

When it is determined that adjustment is needed, the resource allocation plan generation module 1002 adjusts the resource allocation plan for one or more previously-planned jobs based on actual resource requirements. The adjustment may comprise re-planning all subtasks or re-planning individual subtasks to stay on schedule locally. For example, the adjustment may comprise raising downstream job allocations. In this manner, using the execution monitoring module 408, top-level SLAs can be met even in cases where the original resource requirement was incorrectly planned.

In one embodiment, upon determining that adjustment of the resource allocation plan(s) is needed, resource allocation plan generation module 1002 assesses whether enough capacity is present in the existing resource allocation plan(s) to allow adjustment thereof. If this is not the case, resource allocation plan generation module 1002 outputs information indicating that no adjustment is possible. This information may be output to a user using suitable output means. For example, adjustment of the resource allocation plan(s) may be impossible if resource allocation plan generation module 1002 determines that some subtasks require more resources than originally planned. In another embodiment, the priority of different workflows is taken into consideration and resource allocation plan(s) adjusted so that higher-capacity tasks may complete, even if the entire capacity has been spent. In particular, even if no spare capacity exists in the resource allocation plan(s), in this embodiment resource allocation plan generation module 1002 allocates resources from one subtask to another higher-capacity subtask. In yet another embodiment, resource allocation plan generation module 1002 adjusts the existing resource allocation plan(s) so that, although a given SLA is missed, a greater number of SLAs might be met.

In some embodiments, the planned resource allocations of already submitted jobs may not be changed, as that would necessitate re-assigning resource pools. In other embodiments, the resource pool of a running job may be changed, for example, to give it more resources if it is running longer than expected and an adjusted resource allocation plan indicates that it should have more resources.

Having determined the actual workload progress, execution information acquiring module 1102 of execution monitoring module 408 also sends the execution information to pool assignment module 407 to update the record of available resource pools 520. Pool assignment module 407 may receive notification that job starts running, and receive notification that job finishes, to release the assigned resource pool 520 and update the record of available pools.

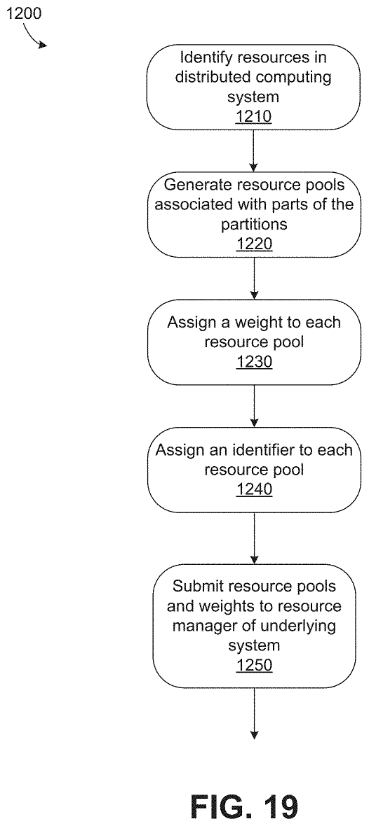

FIG. 19 illustrates a flowchart of steps for resource pool pre-creation 1200, in accordance with an embodiment. Resource pool pre-creation 1200 is an initialization process, to initialize underlying system 306 with pools via resource partitioning before operation of running a workload. Resource pool pre-creation 1200 is performed by execution of pool pre-creation module 401.

Pool pre-creation module 401, upon receiving data indicative of a total number of computing resources 150 in a compute cluster of distributed computing system 100, identifies resources of the total resources at resource discovery module 502 (step 1210).

The next step is generating resource pools at resource pool generator module 504 in accordance with the total number of computing resources 150 (step 1220). Each of the resource pools is associated with a quantity of computing resources 150 that is included in one or more partitions, namely a subset of resources, of the total quantity of resources 150.

At weight assignment module 508, a weight is then assigned to each resource pool based on the quantity of computing resources associated with that resource pool (step 1230).

At identifier module 506, a resource pool identifier may be assigned to each resource pool (step 1240).

In some embodiments, the defined resource pools are initialized to a list of available resource pools, as being a resource available for a subtask to be assigned to, to execute the subtask.

The defined resource pools, resource pool identifiers and weights are then submitted to the scheduler of the underlying system resource manager 314 of the compute cluster (step 1250).

Resource pool pre-creation 1200 is implemented by SLA planning unit 302 prior to jobs being submitted to underlying system 306.

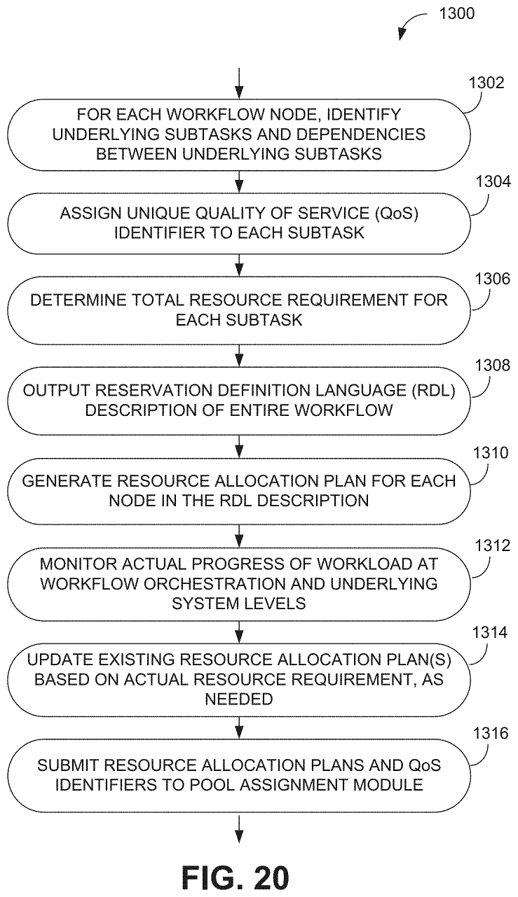

Referring now to FIG. 20, an example method 1300 for generating and updating resource allocation plans will now be described. The method 1300 is implemented by SLA planning unit 302 prior to jobs being submitted to underlying system 306 and after pool pre-creation module 401 has defined resource pools 520. Method 1300 comprises at step 1302 identifying, for each workflow node, underlying subtasks and dependencies between the underlying subtasks. A unique quality of service (QoS) identifier is then assigned at step 1304 to each subtask. A total resource requirement is further determined for each subtask at step 1306. A reservation definition language (RDL) description of the entire workflow is output at step 1308 and a resource allocation plan generated for each node in the RDL description at step 1310. The next step 1312 is to monitor the actual progress of workload at the workflow orchestration and underlying system levels. At step 1314, one or more existing resource allocations are then updated based on the actual resource requirement, as needed. The resource allocation plans and the corresponding QoS identifiers are then submitted to pool assignment module 407 (step 1316).

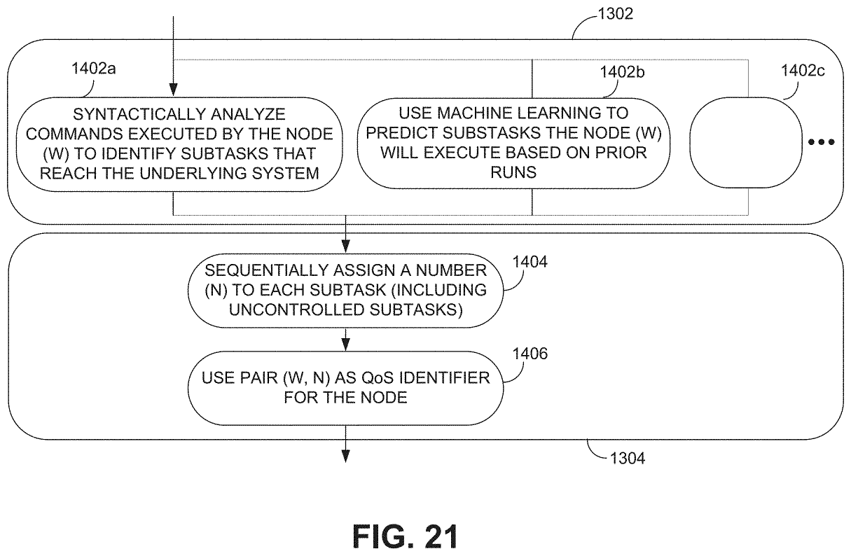

Referring now to FIG. 21, in one embodiment, step 1302 of identifying underlying subtasks for each workflow node comprises syntactically analyzing commands executed by the node (W) to identify the subtasks that impact operation of the underlying system (step 1402a). In another embodiment, the step 1302 of identifying underlying subtasks for each workflow node comprises using machine learning techniques to predict the subtasks that the node (W) will execute based on prior runs (step 1402b). As discussed above, underlying subtasks may be discovered using a number of techniques other than syntactical analysis or prediction (as illustrated by step 1402c). For example, although not illustrated in FIG. 21, the step 1302 may comprise receiving a user-provided prediction as to what the underlying subtasks will be. Other embodiments may apply. The step 1304 of assigning a QoS identifier to each subtask then comprises sequentially assigning (step 1404) a number (N) to each previously-identified subtask (including uncontrolled subtasks). The pair (W, N) is then used as the QoS identifier for the node at hand (step 1406).

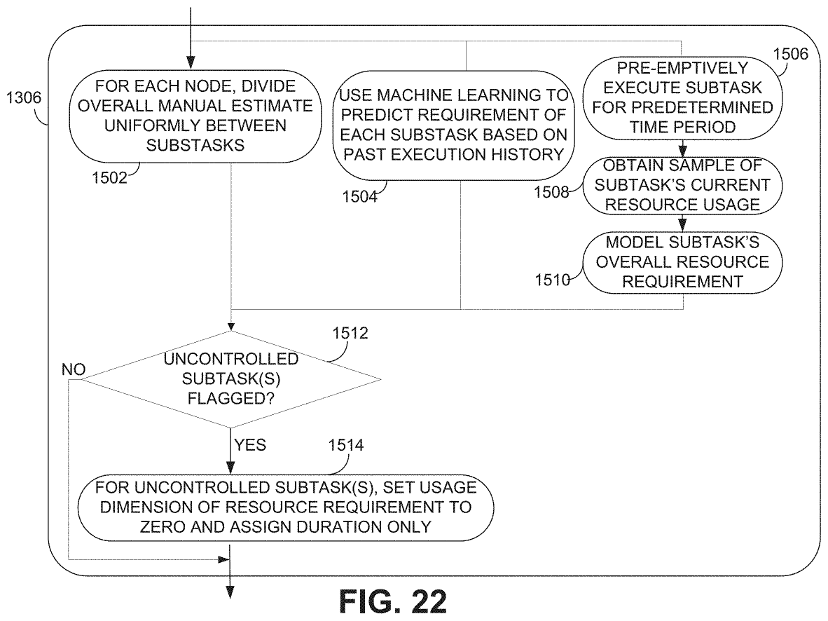

Referring to FIG. 22, in one embodiment, the step 1306 comprises dividing at step 1502 an overall manual estimate uniformly between the subtasks of each node, e.g. a manual estimate received through user input. In another embodiment, machine learning is used at step 1504 to predict the resource requirement of each subtask based on past execution history. In yet another embodiment, each subtask is pre-emptively executed for a predetermined time period (step 1506). The subtask is then terminated and a sample of the current resource usage of the subtask is obtained at step 1508. The current resource usage sample is then used at step 1510 to model the overall resource requirement for the subtask. Other embodiments may apply for determining the total resource requirement for each subtask (as illustrated by step 1512). The next step 1514 is then to assess whether any uncontrolled subtasks have been flagged during the QoS identifier generation process (steps 1302 and 1304 of FIG. 20). If this is not the case, the method 1300 proceeds to the next step 1308. Otherwise, the next step 1516 is to set the usage dimension of the resource requirement for the uncontrolled subtask(s) to zero and only assign duration to the uncontrolled subtask(s).

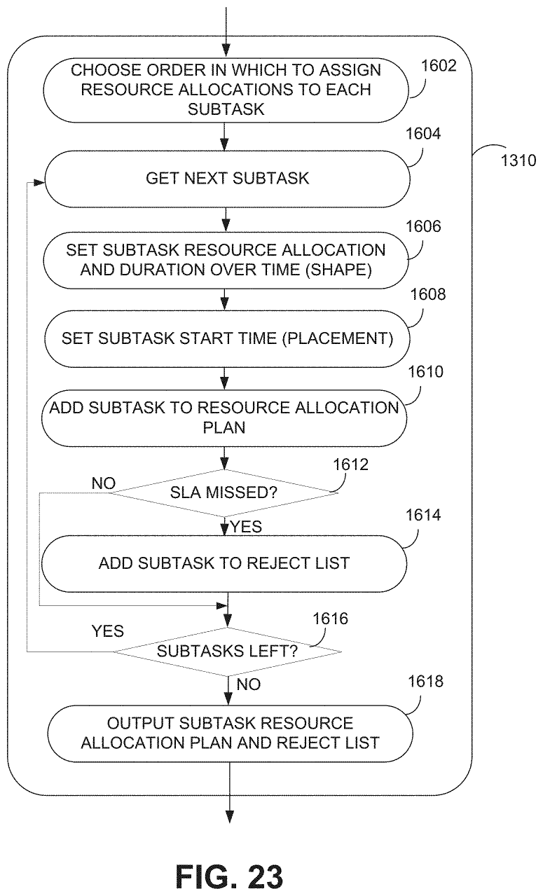

Referring now to FIG. 23, the step 1310 of generating a resource allocation plan comprises choosing at step 1602 an order in which to assign resource allocations to each subtask. Once the order has been chosen, the next step 1604 is to get the next subtask. The resource allocation and duration over time (i.e. the shape) for the current subtask is then set at step 1606. The subtask start time (i.e. the placement) is then set at step 1608 and the subtask is added to the resource allocation plan at step 1610. The next step 1612 is then to assess whether a deadline has been missed for the current subtask. If this is the case, the subtask is added to a reject list at step 1614. Otherwise, the next step 1616 is to determine whether there remains subtasks to which a resource allocation is to be assigned. If this is the case, the method returns to step 1604 and gets the next subtask. Otherwise, the resource allocation plan and reject list are output at step 1618.

As discussed above, various embodiments may apply for selecting the order, shape, and placement of the subtasks. For example, the choice of order, shape, and placement can be made heuristically, in order to optimize an objective function, or in a random manner. Critical jobs can also be ordered, shaped, and placed, before less-critical jobs. Other embodiments may apply. It should also be understood that the steps 1602, 1606, and 1608 can be performed in a different sequence or in an interleaved or iterative manner.

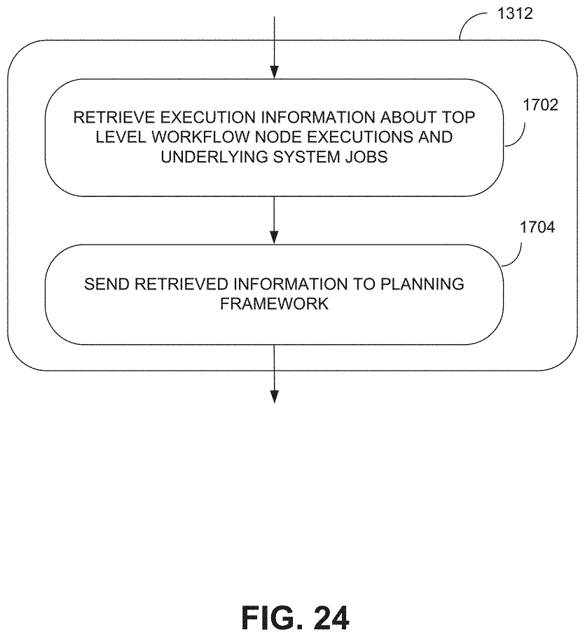

Referring to FIG. 24, the step 1012 of monitoring the actual progress of the workload at the workflow orchestration and underlying system levels comprises retrieving at step 1702 execution information about top level workflow node executions and underlying system jobs. The retrieved information is then sent to the planning framework at step 1704 for causing adjustment of one or more existing resource allocation plans.

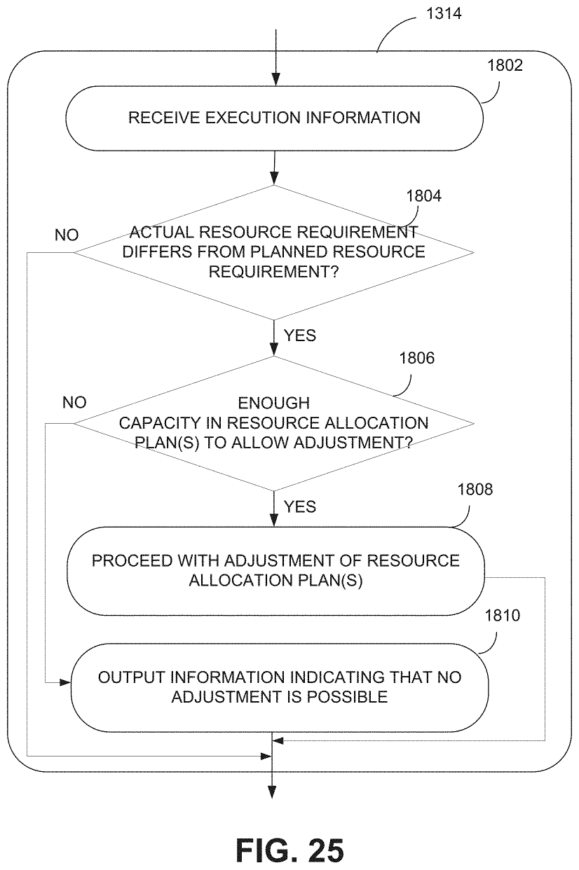

As illustrated in FIG. 25, the step 1314 of updating one or more existing resource allocation plans based on the actual resource requirement comprises receiving the execution information at step 1802 and assessing, based on the received execution information, whether the actual resource requirement differs from the planned resource requirement (step 1804). If this is not the case, the method flows to the next step, i.e. step 1316 of FIG. 20. Otherwise, in one embodiment, the next step 1806 is to assess whether there is enough capacity in the existing resource allocation plan(s) to allow adjustment. If this is the case, the next step 1808 is to proceed with adjustment of the existing resource allocation plan(s) based on the actual workload execution information and on the actual resource requirement. Otherwise, information indicating that no adjustment is possible is output (e.g. to the user, step 1810) and the method then flows to step 1316. As discussed above, other embodiments may apply. For example, even if no spare capacity exists in the resource allocation plan(s), resources from one subtask may be allocated to a higher-capacity subtask. Alternatively, the existing resource allocation plan(s) may be adjusted so that, although a given SLA is missed, a greater number of SLAs is met.

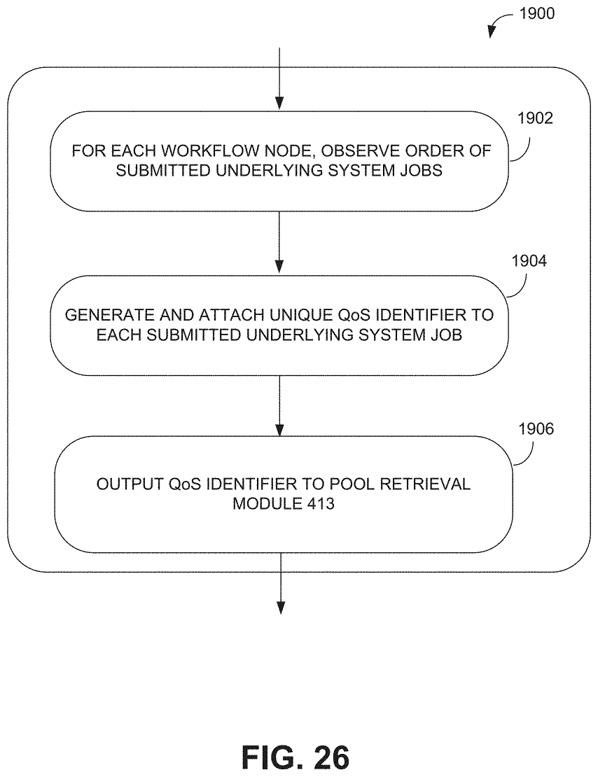

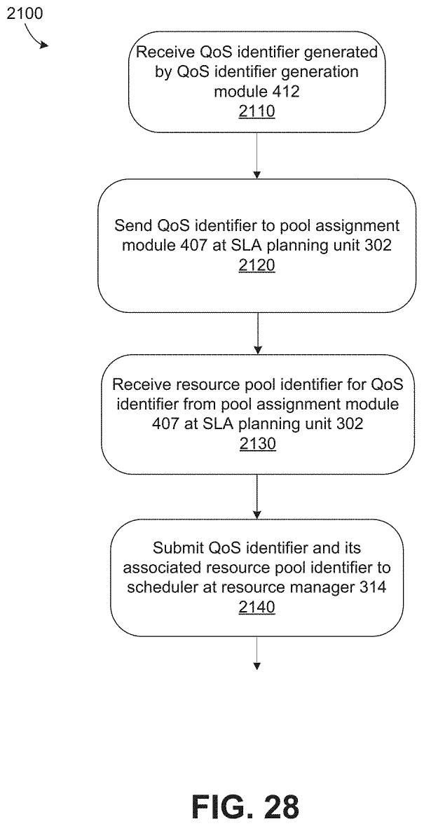

Referring now to FIG. 26, a QoS identifier generation procedure 1900, which in part replicates step 1304 of FIG. 20, is implemented at the underlying system 306. The procedure 1900 comprises at step 1902, for each workflow node, observing the order of submitted underlying system jobs. A unique QoS identifier is then generated and attached to each submitted job at step 1904. The next step 1906 is then to output the QoS identifier to pool identifier module 413 to identify a resource pool to associate with that job, as described with reference to FIG. 28, below.

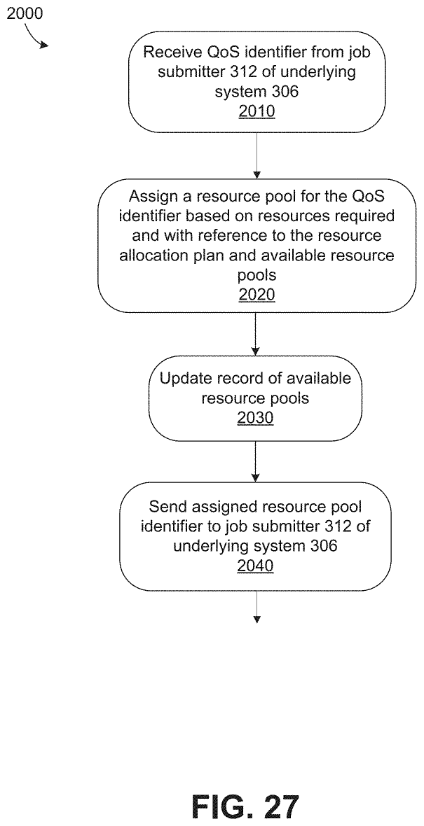

Referring now to FIG. 27, a pool assignment procedure 2000 is implemented by pool assignment module 407 at SLA planning unit 302. Procedure 2000 beings at step 2010, receiving QoS identifier from job submitter 312 of underlying system 306, the QoS identifier identifying the job for which a resource pool is to be assigned.

Then, at step 2020, a resource pool is selected and assigned to the QoS identifier based on the resources required, with reference to the resource allocation plan and the resource pool that are available.

At step 2030 the list of available resource pools may be updated.

At step 2040, the assigned resource pool identifier is sent to job submitter 312 of underlying system 306. In some embodiments, this step may include sending a submit time to job submitter 312, indicating a start time for the job identified by QoS identifier. The start time may be indicated in the resource allocation plan.

Referring now to FIG. 28, a resource pool identifying procedure 2100 is implemented at job submitter 312 to retrieve a resource pool identifier for a QoS identifier. Resource pool identifying procedure 2200 occurs at job submitter 312, in conjunction with pool assignment procedure 2000 at SLA planning unit 302.

At step 2110, a QoS identifier, generated by QoS identifier generation module 412, is received.

At step 2120, the QoS identifier is transmitted to SLA planning module 302, and more specifically, pool assignment module 407, to retrieve a resource pool 520 for a particular QoS identifier, at step 2130. A resource pool 520 identifier is also received. Optionally, a start time may also be received.

At step S2130, the QoS identifier and its assigned resource pool 520 identifier is then sent, in an example, at a start time, to scheduler in resource manager 314.

Resource manager 314, having received the defined resource pools 520 during pool pre-creation, is therefore able to assign the appropriate resources to a subtask, based on the resource pool 520 that is assigned to that QoS identifier. Resource manager 314 knows what the resource pools are, and how many resources a particular resource pool identifier signifies, and a job can then start running using the designated resources.

Notification of a job start/finish may be send from underlying system 306/control system to execution monitoring module 408 in SLA planning unit 302.

A scheduler, for example a fair scheduler, at resource manager 314 enforces the level of QoS specified in the resource allocation plan for the planned workflow nodes. In this manner, it is possible to ensure that jobs can be completed by the specified deadlines and SLAs met as per user requirements.

In this way, the system may enforce the level of QoS specified in the resource allocation plan for jobs submitted with the same QoS identifiers as the QoS identifiers associated with planned workflow nodes. As a result, it is possible to ensure that submitted jobs, which are presented at the underlying system level, attain a particular level of service, thereby meeting the business workflow SLA.

Resource allocation may be done without the need for a control system (for example, scheduler in underlying system 306) that supports dynamic reservations.

By pre-creating resource pools for all possible partitionings, a resource plan may be enforced at any moment in time, regardless of how the resources are partitioned between the running jobs.

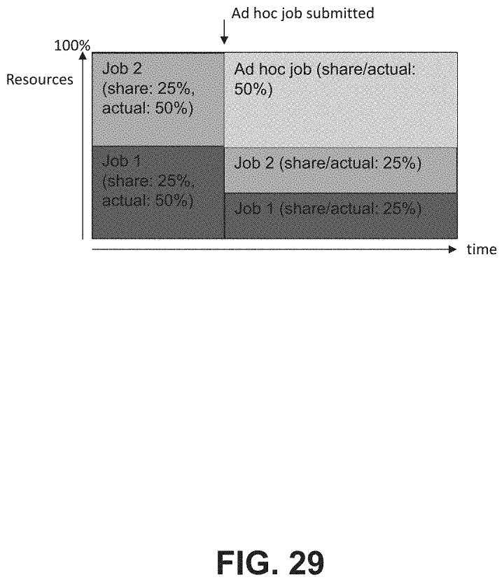

Referring to FIG. 29, in some embodiments, clusters of resources 150 may run un-planned “ad hoc” jobs or subtasks. In combination with the resource pool pre-creation, as described above, dedicated ad hoc pools may be defined in defined resource pools 520, which may guarantee resources for ad hoc jobs. When an ad hoc job starts or finishes, other pools may automatically shrink or expand, in response. In an example, resource pools 520 for planned jobs may constitute 50% of a resource cluster, and resource pools 520 for ad hoc jobs may constitute 50% of the resource cluster, as shown in FIG. 29. Job submitter 312 may thus send to pool assignment module 407 a job identifier, or QoS identifier, for an unplanned job, and a resource pool 520 for ad hoc jobs may be selected and sent to job submitter 312.

In some embodiments, different resource guarantees may be provided for multiple tenants or multiple users, by providing multiple ad hoc pools.

In some embodiments, a different amount of resource clusters may be reserved at different times of day for ad hoc jobs or other work. For example, particular work may be planned during daytime hours. A planner may plan to a different maximum at different times of days, and users can submit to an ad hoc pool with the appropriate weight for that time of day.

In schedulers that do not support resource pool re-assignment, job pools are fixed once a job starts running. However, to a certain extent, resources available to jobs may be changed after they have started running.

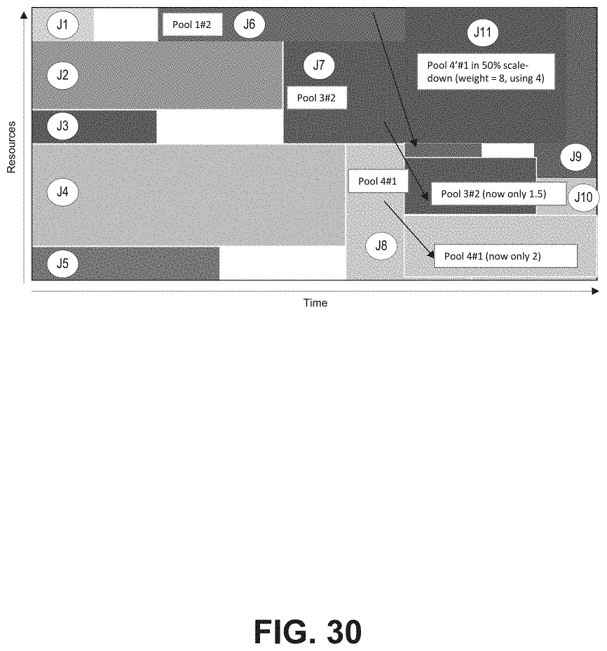

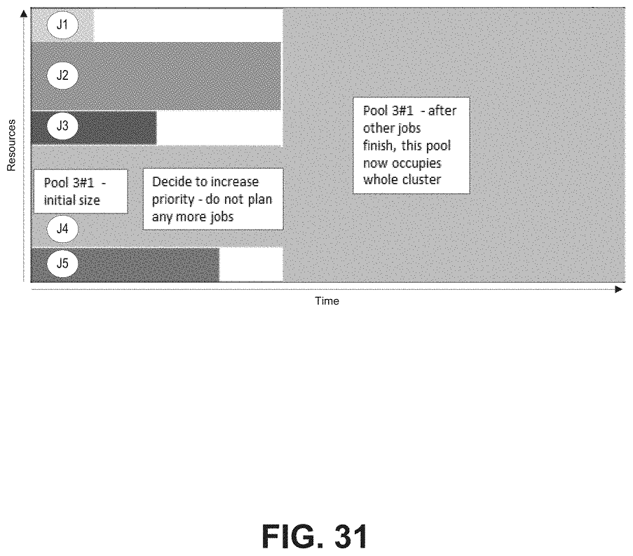

Referring to FIGS. 30 and 31, in some embodiments, extra resource pools 520 may be pre-defined with higher weights and/or lower weights, so that running jobs (subtasks) may be dynamically down-sized and/or upsized. By starting to use a new set of resource pools, existing jobs using an existing set of resource pools 520 will logically have lower/higher weight than they did in the original resource allocation plan.

FIG. 30 illustrates planning a collective down-sizing of running jobs, in accordance with an embodiment. Each shape represents the resource allocation (“Resources” axis) and duration over time (“Time” axis) for the current subtask (or “job”), “J”. FIG. 30 illustrates ten jobs identified as “J1” to “J11”. While FIG. 30 uses rectangles to illustrate the planned shapes for each job, it should be understood that other shapes can be used in practice.

As shown in FIG. 30, to permit collectively sizing down all running jobs, extra resource pools 520 may be pre-defined in advance, such that by assigning extra jobs to these pools (to run simultaneously with the already-running jobs), the already-running jobs will get a smaller share of the resources.

In the example shown in FIG. 30, a job (“J11”) may be assigned to pool 4′#1, which gets four units of resources, by giving it a weight 8. This causes all running jobs (“J6”, “J7” and “J8”) to now get 50% of their existing resources. Essentially, running jobs are logically reduced to 50% of their previous size, and 50% of the resource cluster is now available to place “J11” in pool 4′#1, or as a subset of pool 4′#11 to place “extra” or other jobs into the “extra” pools, e.g., 1′#1, 2′#1, 3′#1, etc. (each with double weight).

This may allow flexibility to the planner to down-weight running jobs so that new jobs may run faster.

In an example, a resource pool 520 may be pre-defined with a very large weight (for example, 1,000,000) so that all running jobs may be delayed until the job in the high-priority pool is finished. A benefit of this approach may be no requirement of real changes or enhancements to duration and prediction, since the running jobs are shifter later and not re-sized in the middle of operation.

Turning to FIG. 31, each shape represents the resource allocation (“Resources” axis) and duration over time (“Time” axis) for the current subtask (or “job”), “J”. FIG. 30 illustrates five jobs identified as “J1” to “J5”. While FIG. 31 uses rectangles to illustrate the planned shapes for each job, it should be understood that other shapes can be used in practice.

As shown in FIG. 31, the start of jobs may be delayed so that running jobs can occupy more of the cluster resources by collectively sizing up all running jobs. In order to give running jobs extra resources, the scheduling of new jobs may be delayed. Once running jobs start finishing, other running jobs will get the appropriate resources. This is illustrated, in an example, in FIG. 31, in which scheduling of new jobs is delayed to allow pool 3#1 (job “J4”) to occupy the entire cluster of resources.

As shown in FIG. 31, a single resource pool 520 may be defined with a very high weight that would effectively pre-empt all of the running jobs and occupy an entire cluster of resources. This may be useful, for example, if a job suddenly becomes very high priority.

In another embodiment, extra resource pools 520 may be pre-defined at a lower weight (for example, pools with 50% of the weight of the pools used in the running jobs), and then switch to planning and assigning to the lower-weight pools. Essentially, running jobs would switch to logically using two times their existing resources.

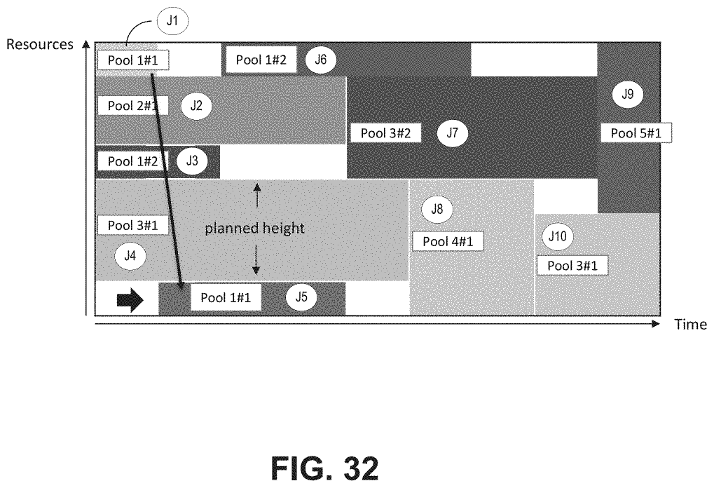

Referring to FIG. 32, in some embodiments a certain number of pre-defined pools 520 may be omitted, and the planning algorithm adjusted to take action (for example, adding a dependency, re-sizing a job and re-planning) if no pools of the desired weight are available. Each shape in FIG. 32 represents the resource allocation (“Resources” axis) and duration over time (“Time” axis) for the current subtask (or “job”), “J”. FIG. 32 illustrates ten jobs identified as “J1” to “J10”. While FIG. 32 uses rectangles to illustrate the planned shapes for each job, it should be understood that other shapes can be used in practice. In FIG. 32, a dependency is placed between job “J5” and job “J1”, meaning that job “J5” cannot start until job “J1” is finished, because job “J5” needs a pool of weight 1.

It may be unlikely that all resource pools 520 will be needed. For example, it may be unlikely that the thousandth pool of weight 1 (1#1000) would be needed out of 1000 available resources, since it may by unlikely that a thousand jobs would simultaneously allocated to one core each. Instead, in some embodiments a restricted pool pre-creation may be done, resulting in a smaller pool definition.

In the example shown in FIG. 32, with 8 total resources, pool definition may be as follows: 8×1#_: 1#1, 1#2, 1#3, . . . 1#8; 4×2#_: 2#1, 2#2, 2#3, 2#4; 2×3#_: 3#1, 3#2; 2×4#_: 4#1, 4#2; 1×5#_: 5#1; 1×6#_: 6#1; 1×7#_: 7#1; and 1×8#_: 8#1. In a restricted pool pre-creation, pools 1#3, . . . 1#8, 2#3 and 2#4 may be omitted.

The planner may consider modifying a plan given knowledge of a restricted pool definition. In an example, a pool assignment process may run forward in time to detect jobs where the queue of available pools is empty. If there are none, then the process may proceed as normal. If an available pool is empty, than a new dependency may be added between such jobs and an earlier job using a pool of the desired size, so that the problematic job starts after the earlier job, once its pool is available, as shown in an example in FIG. 32 in the dependency between job “J5” and job “J1”. A job size may also be changed such that the pool of the desired size is available. The resources may be re-planned given the new dependencies and/or job sized.

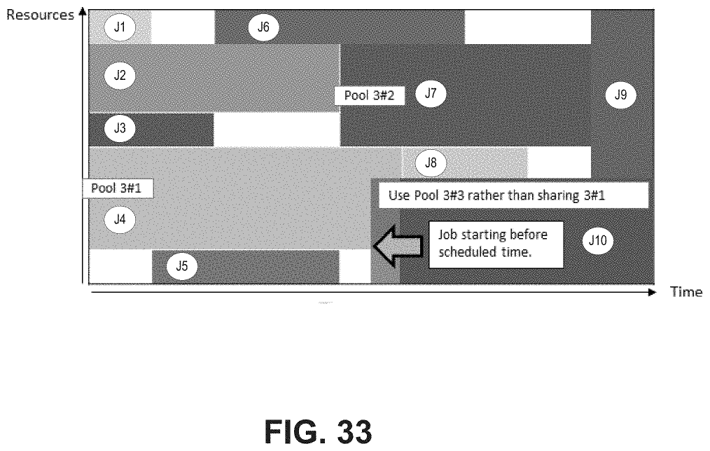

Referring to FIG. 33, each shape represents the resource allocation (“Resources” axis) and duration over time (“Time” axis) for the current subtask (or “job”), “J”. FIG. 33 illustrates ten jobs identified as “J1” to “J10”. While FIG. 33 uses rectangles to illustrate the planned shapes for each job, it should be understood that other shapes can be used in practice. Redundant resource pools 520 may be added to handle cases where jobs do not start and stop exactly as planned, requiring more resource pools of a certain size than are actually available.

In situations where jobs may not perfectly respect scheduled start times, a job may start early when no pools are yet available. If a job is submitted to the same pool as a running job, both jobs will get 50% of the pool's resources. Alternatively, in some embodiments, one or more “redundant” pools may be pre-defined for each size, and added to the available pool queue along with the other pool identifiers. When jobs start early, all jobs in a resource cluster may get proportionally less resources.

In an example of 8 available resources, pool definition may be 8×1#_: 1#1, 1#2, 1#3, . . . 1#8; 4×2#_: 2#1, 2#2, 2#3, 2#4; 23×3#_: 3#1, 3#2; 2×4#_: 4#1, 4#2; 1×5#_: 5#1; 1×6#_: 6#1; 1×7#_: 7#1; and 1×8#_: 8#1. Ina redundant pool embodiments, one extra “redundant” pool for each size may be 1#9, 2#5, 3#, 4#3, 5#2, 6#2, 7#2 and 8#2. In an example as shown in FIG. 33, redundant pool 3#3 may be used rather than sharing 3#1 for a job (“J10”) starting before its scheduled time.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A method in a distributed computing system comprising:
receiving data indicative of a total number of computing resources in a compute cluster of the distributed computing system;
generating a plurality of resource pools in accordance with the total number of computing resources, each of the plurality of resource pools associated with a quantity of computing resources that is included in one or more partitions of the total quantity of resources;
assigning a weight to each of the plurality of resource pools based on the quantity of computing resources associated with each resource pool; and
sending the plurality of resource pools and the weights assigned to each resource pool to a scheduler of the compute cluster.

2. The method of claim 1, further comprising:
receiving, from a job submitter of the distributed computing system, a job identifier for a job;
selecting a resource pool of the plurality of resource pools for the job based on a resource allocation for the job, the resource allocation indicative of a number of computing resources in the compute cluster allocated for execution of the job; and
sending the selected resource pool to the job submitter.

3. The method of claim 2, wherein the sending the selected resource pool to the job submitter comprises sending the selected resource pool to the job submitter for submission to the scheduler, and for the scheduler to assign computing resources in the compute cluster for execution of the job based on the selected resource pool.

4. The method of claim 2, wherein the selected resource pool is associated with the quantity of computing resources to which another job has not been assigned.

5. The method of claim 2, further comprising:
receiving, from the job submitter of the distributed computing system, a second job identifier for a second job;
selecting a second resource pool of the plurality of resource pools to the second job based on a second resource allocation for the second job, the second resource allocation indicative of a number of computing resources in the compute cluster allocated for execution of the second job; and
sending the selected second resource pool to the job submitter.

6. The method of claim 2, further comprising after sending the selected resource pool to the job submitter, indicating that the selected resource pool is unavailable for selection, and indicating that the selected resource pool is available for selection after receipt of a notification that execution of the job is completed.

7. The method of claim 2, wherein the plurality of resource pools comprises at least one ad hoc resource pool and one or more planned job resource pools, and the job is a planned job, and the selected resource pool is one of the one or more planned job resource pools.

8. The method of claim 7, further comprising receiving, from the job submitter, a job identifier for an unplanned job, and selecting one of the at least one ad hoc resource pool.

9. The method of claim 1, wherein the weight of a resource pool is determined based on a proportion of the quantity of computing resources associated with the resource pool relative to the total quantity of computing resources in the compute cluster.

10. The method of claim 9, wherein the plurality of resource pools is associated with the total number of computing resources in the compute cluster.

11. The method of claim 2, further comprising selecting another resource pool of the plurality of resource pools for the job while the job is being executed and sending the another selected resource pool to the job submitter.

12. A distributed computing system comprising:
at least one processing unit; and
a non-transitory memory communicatively coupled to the at least one processing unit and comprising computer-readable program instructions executable by the at least one processing unit for:
receiving data indicative of a total number of computing resources in a compute cluster of the distributed computing system;
generating a plurality of resource pools in accordance with the total number of computing resources, each of the plurality of resource pools associated with a quantity of computing resources that is included in one or more partitions of the total quantity of resources;
assigning a weight to each of the plurality of resource pools based on the quantity of computing resources associated with each resource pool; and
sending the plurality of resource pools and the weights assigned to each resource pool to a scheduler of the compute cluster.

13. The distributed computing system of claim 12, wherein the computer-readable program instructions are executable by the at least one processing unit for:
receiving, from a job submitter of the computer cluster, a job identifier for a job;
selecting a resource pool of the plurality of resource pools for the job based on a resource allocation for the job, the resource allocation indicative of a number of computing resources in the compute cluster allocated for execution of the job; and
sending the selected resource pool to the job submitter.

14. The distributed computing system of claim 13, wherein the sending the selected resource pool to the job submitter comprises sending the selected resource pool to the job submitter for submission to the scheduler, and for the scheduler to assign computing resources in the compute cluster for execution of the job based on the selected resource pool.

15. The distributing computing system of claim 12, wherein the computer-readable program instructions are executable by the at least one processing unit for: after sending the selected resource pool to the job submitter, indicating that the selected resource pool is unavailable for selection, and indicating that the selected resource pool is available for selection after receipt of a notification that execution of the job is completed.

16. The distributed computing system of claim 13, wherein the plurality of resource pools comprises at least one ad hoc resource pool and one or more planned job resource pools, and the job is a planned job, and the selected resource pool is one of the one or more planned job resource pools.

17. The distributed computing system of claim 13, the computer-readable program instructions are executable by the at least one processing unit for: receiving, from the job submitter, a job identifier for an unplanned job, and selecting one of the at least one ad hoc resource pool.

18. The distributed computing system of claim 12, wherein the weight of a resource pool is determined based on a proportion of the quantity of computing resources associated with the resource pool relative to the total quantity of computing resources in the compute cluster.

19. The distributed computing system of claim 18, wherein the plurality of resource pools is associated with the total number of computing resources in the compute cluster.

20. The distributed computing system of claim 12, the computer-readable program instructions are executable by the at least one processing unit for: selecting another resource pool of the plurality of resource pools for the job while the job is being executed and sending the another selected resource pool to the job submitter.
